(19) United States
(12) Patent Application Publication
(10) Pub. No.: US 2014/0009836 A1
(43) Pub. Date: Jan. 9, 2014

(54) WOOD-LIKE FILMS AND OTHER DECORATIVE FILMS UTILIZING FRESNEL MIRRORS

(71) Applicants: Michael F. Weber, Shoreview, MN (US); Tommie W. Kelley, Shoreview, MN (US); Lynn E. Lorimor, Minneapolis, MN (US); Gilles J.B. Benoit, Minneapolis, MN (US); James M. Nelson, Lino Lakes, MN (US)

(72) Inventors: Michael F. Weber, Shoreview, MN (US); Tommie W. Kelley, Shoreview, MN (US); Lynn E. Lorimor, Minneapolis, MN (US); Gilles J.B. Benoit, Minneapolis, MN (US); James M. Nelson, Lino Lakes, MN (US)

(73) Assignee: 3M Innovative Properties Company

(21) Appl. No.: 13/540,733

(22) Filed: Jul. 3, 2012

(51) Int. Cl. G02B 5/02; G02B 5/09

(52) U.S. Cl. 359/599; 359/851

(57) ABSTRACT

A decorative film having a wood-like 3-dimensional appearance includes a plurality of Fresnel mirrors extending generally parallel to an in-plane axis, a diffuser disposed to scatter light reflected by the Fresnel mirrors, and wood-grain indicia disposed to cover the Fresnel mirrors. Embodiments of the film can be made to simulate highly figured wood such as flame maple, also called fiddleback maple. Other decorative articles that utilize Fresnel mirrors are also disclosed. At least some of these other articles do not have a wood-like appearance, and they may include a Fresnel mirror film in combination with other components such as a Fresnel lens film or other light-transmissive film(s).

### FIELD OF THE INVENTION

This invention relates generally to decorative films having unique appearances, with particular application to such films that incorporate a Fresnel mirror. The invention also relates to associated articles, systems, and methods.

### BACKGROUND

About 200 years ago, French physicist Augustin-Jean Fresnel is said to have developed thinner, lighter lenses for use in early 19^{th} century lighthouses. We refer to these lenses today as Fresnel lenses. Since that time, Fresnel lenses have been used in a multitude of applications to provide focusing of light in a thinner and lighter form than could be provided by a bulk optical lens. It was also found that curved mirrors could be replaced by analogous thin, faceted constructions by making the facets reflective. Such mirrors are referred to as Fresnel mirrors.

### BRIEF SUMMARY

We have developed a family of wood-like films and other decorative films that utilize Fresnel mirrors. The Fresnel mirrors can be incorporated into the films to provide a unique 3-dimensional appearance. The decorative films preferably incorporate additional features such as diffusers, indicia, and/or Fresnel lenses that are arranged relative to the Fresnel mirrors for unique visual effects. In some cases, the films can be designed to have the appearance of a highly figured wood such as flame maple or flame birch.

We describe herein, for example, a decorative film having a wood-like 3-dimensional appearance. This decorative film includes a plurality of Fresnel mirrors, a diffuser disposed to scatter light reflected by the Fresnel mirrors, and wood-grain indicia disposed to cover the Fresnel mirrors. The Fresnel mirrors may each extend generally parallel to an in-plane axis. Embodiments of the film can be made to simulate highly figured wood such as flame maple or flame birch. Other decorative articles that utilize Fresnel mirrors are also disclosed. At least some of these other articles do not have a wood-like appearance, and they may include a Fresnel mirror film in combination with other components such as a Fresnel lens film or other light-transmissive film(s).

The present application discloses, inter alia, film articles having a wood-like 3-dimensional appearance. Such film articles include a first film, a diffuser, and an indicia layer. The first film has a plurality of Fresnel mirrors, each of the Fresnel mirrors extending generally parallel to a first in-plane axis. The diffuser is disposed to scatter light reflected by the Fresnel mirrors. The indicia layer includes wood-grain indicia, and is disposed to cover the first film.

The diffuser may be tailored to diffuse light preferentially along a second in-plane axis, and the second in-plane axis may be substantially aligned with the first in-plane axis. For example, the first and second in-plane axes may form an angle less than 30 degrees. The diffuser may be characterized such that if it is illuminated by a normally incident collimated light beam, it scatters the light beam by a characteristic polar scattering angle β in a plane containing the second in-plane axis, and by a second characteristic polar scattering angle α degrees in a plane containing a third in-plane axis perpendicular to the second in-plane axis, and wherein β/α is at least 1.5.

In some cases, the diffuser may be incorporated into the indicia layer, or the diffuser can be part of the mirrored structured surface. In some cases, at least some of the Fresnel mirrors may be configured to focus incident parallel light, and in some cases, at least some of the Fresnel mirrors may be configured to defocus incident parallel light. The Fresnel mirrors may also be arranged to alternate between first Fresnel mirrors configured to focus incident parallel light and second Fresnel mirrors configured to defocus incident parallel light. The Fresnel mirrors may be contiguous to each other. The Fresnel mirrors may each be straight in plan view.

The wood-grain indicia may include wood-grain features that each extend parallel to a third in-plane axis, and the third in-plane axis may be substantially perpendicular to the first in-plane axis.

Each of the Fresnel mirrors may comprise a plurality of reflective facets formed on the first film.

We also describe film articles that include a first film and a diffuser. The first film has a plurality of Fresnel mirrors, each of the Fresnel mirrors extending generally parallel to a first in-plane axis. The diffuser is disposed to scatter light reflected by the Fresnel mirrors, and diffuses light preferentially along a second in-plane axis that is substantially aligned with the first in-plane axis. The first and second in-plane axes may form an angle less than 60, 45, or 30 degrees. At least some of the Fresnel mirrors may be configured to focus incident parallel light, and at least some of the Fresnel mirrors may be configured to defocus incident parallel light. The Fresnel mirrors may each have a length-to-width aspect ratio, and the aspect ratios of the plurality of Fresnel mirrors may each be greater than 10. In plan view, the Fresnel mirrors may each be straight, or each may deviate from a straight line. The article may also include an indicia layer covering the Fresnel mirrors and including indicia features that each extend parallel to a third in-plane axis.

We also describe a film stack that includes a first film, a second film, and an optional diffuser. The first film has a plurality of Fresnel mirrors, each of the Fresnel mirrors extending generally parallel to a first in-plane axis. The second film has a plurality of Fresnel lenses, each of the Fresnel lenses extending generally parallel to a second in-plane axis, the second film being disposed to intercept light reflected by the Fresnel mirrors. The diffuser may be disposed to scatter light reflected by the Fresnel mirrors. The second in-plane axis is non-parallel to the first in-plane axis. The diffuser may have a haze in a range from 0 to 90%. The diffuser may diffuse light preferentially along a third in-plane axis, and the diffuser may be oriented such that the third in-plane axis is perpendicular to neither the first in-plane axis nor the second in-plane axis. The diffuser may be incorporated into the first film and/or the second film. The first and second in-plane axes may form an angle in a range from 5 to 90 degrees. One or more colored dyes and/or pigments may also be incorporated into one or more components of the film stack.

The plurality of Fresnel mirrors may be characterized by an average Fresnel mirror width and the plurality of Fresnel lenses may be characterized by an average Fresnel lens width different from the average Fresnel mirror width. The plurality of Fresnel mirrors may be characterized by a first average pitch, and the plurality of Fresnel lenses may be characterized by a second average pitch different from the first average pitch. The first film in the stack may attach to a first major surface of a window or other transparent plate, and the second film may attach to a second major surface, opposite the first major surface, of the window or plate.

We also describe a decorative mirror film that includes a structured surface having facets arranged in a slope sequence from a first substantially zero slope to increasingly positive slopes to a maximum positive slope to diminishing positive slopes to a second substantially zero slope to increasingly negative slopes to a maximum negative slope to diminishing negative slopes to the first substantially zero slope, the sequence repeating in a substantially uninterrupted fashion across the structured surface, the facets defining a plurality of focusing Fresnel mirrors alternating with defocusing Fresnel mirrors. The facets, the focusing Fresnel mirrors, and the defocusing Fresnel mirrors may each extend generally parallel to a first in-plane axis. The slope sequence may be substantially sinusoidal. The slope sequence may have a first periodicity in one region of the film, and a second periodicity different from the first periodicity in a different region of the film. The mirror film may also include an indicia layer covering the focusing and defocusing Fresnel mirrors. The mirror film may also incorporate one or more colored dyes and/or pigments into one or more components of the mirror film. The mirror film may also include visible light diffractive elements tailored to separate visible light into its constituent wavelengths or colors to produce a multicolored visual effect. The mirror film may be combined with a diffuser and an indicia layer to provide a film article. In such a case, the diffuser may be disposed to scatter light reflected by the Fresnel mirrors, and the indicia layer may have wood-grain indicia and may be disposed to cover the mirror film.

Related methods, systems, and articles are also discussed.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF DRAWINGS

In the figures, like reference numerals designate like elements.

FIG. 1a is a photograph of a piece of flame maple (wood), viewed from one perspective, and FIG. 1b is a photograph of the same piece of wood viewed from a different perspective;

FIG. 2 is a schematic side- or cross-sectional view of a film article that can be made to have a 3-dimensional wood-like appearance;

FIG. 2a is a plan view of the Fresnel mirrors of FIG. 2;

FIG. 2b is a schematic side- or cross-sectional view of an article similar to that of FIG. 2, but wherein the Fresnel mirrors are replaced with a corresponding bulk (non-Fresnel) mirror;

FIG. 3 is a schematic diagram of an article that includes an undulating bulk mirror, the diagram showing how incident light from a particular direction is reflected by the mirror;

FIG. 3a is a schematic diagram of the article of FIG. 3, showing how an observer in one orientation perceives the article, and FIG. 3b is analogous to FIG. 3a but for another observer in a different orientation;

FIG. 4 is a schematic side- or cross-sectional view of another film article that can be made to have a 3-dimensional wood-like appearance;

FIG. 4a is a schematic side- or cross-sectional view of an article similar to that of FIG. 4, but wherein the Fresnel mirrors are replaced with corresponding bulk (non-Fresnel) mirrors;

FIG. 5 is a schematic side- or cross-sectional view of another film article that can be made to have a 3-dimensional wood-like appearance;

FIG. 5a is a plan view of the Fresnel mirrors of FIG. 5;

FIG. 5b is a schematic side- or cross-sectional view of an article similar to that of FIG. 5, but wherein the Fresnel mirrors are replaced with corresponding bulk (non-Fresnel) mirrors;

FIGS. 6a and 6b are schematic side- or cross-sectional views that depict two different construction configurations of a Fresnel mirror, one (FIG. 6a) that uses reflective facets, and another (FIG. 6b) that uses transmissive facets in combination with a nearby flat reflector;

FIG. 7 is a schematic perspective view of an exemplary asymmetric diffuser that can be used in the disclosed films;

FIGS. 7a and 7b are possible idealized distributions of intensity versus angle for the scattered light of FIG. 7 in the x-z plane and the y-z plane, respectively;

FIG. 8a is a photograph of a film article having a 3-dimensional wood-like appearance, viewed from one perspective, and FIG. 8b is a photograph of the same film article viewed from a different perspective;

FIG. 9 is a schematic front or plan view of a film stack in which a Fresnel mirror film is disposed below or behind another film component such as a Fresnel lens film;

FIG. 10 is a front or plan view of schematic representations of Fresnel mirrors and Fresnel lenses as they may be arranged in a film stack such as that of FIG. 9;

FIG. 11 is a schematic side- or cross-sectional view of two films adapted for use in a film stack and for application to a workpiece;

FIG. 12 is a simulated representation of a first family of parallel linear sinusoidal structures in combination with a second family of parallel linear sinusoidal structures, the first and second families of structures having an effective intersection angle of about 6 degrees;

FIG. 13 is a photograph of a film stack comprising a Fresnel mirror film having first and second families of parallel linear sinusoidal structures and a Fresnel mirror film having third and fourth families of parallel linear sinusoidal structures, the films being oriented at an intersection angle of about 10 degrees; and

FIG. 14 is a photograph of another film stack comprising a Fresnel lens film and a Fresnel mirror film.

### DETAILED DESCRIPTION OF ILLUSTRATIVE EMBODIMENTS

Wood is one of the most ubiquitous materials known to man. It is available in a great variety of types, such as ash, birch, elm, mahogany, maple, oak, pine, etc., and in a multitude of different colors, textures, grains, and figures, all of which have an effect on the wood's appearance. In many applications, the appearance of the wood has essentially no commercial value because the wood is not exposed or visible in the finished product. Frames for houses or other building structures are examples of such applications. In many other applications, the appearance of the wood has a high commercial value. Hardwood flooring, wall paneling, fine furniture, and musical instruments are examples of such other applications.

Simulated wood products have been known for many years. Such products are typically characterized by a printed wood grain pattern that is essentially 2-dimensional in character and appearance. Even in cases where the simulated wood product employs a surface texture to produce a slightly more realistic look and feel, the surface texture is typically quite shallow, again resulting in a character and appearance that is predominantly 2-dimensional.

Some particularly desirable and expensive wood types have a characteristic referred to as “figure”. “Figure” is associated with stripes or other markings that are distinct from the wood grain and that shift in appearance with changes in illumination geometry and/or observation geometry. For example, a violin or guitar made of a highly figured wood may exhibit stripes or other markings that appear to shift in position along the surface of the wood as the instrument is tilted relative to a given light source and/or observer. The shifting visual effect of the wood figure gives a 3-dimensional quality to the appearance of the wood.

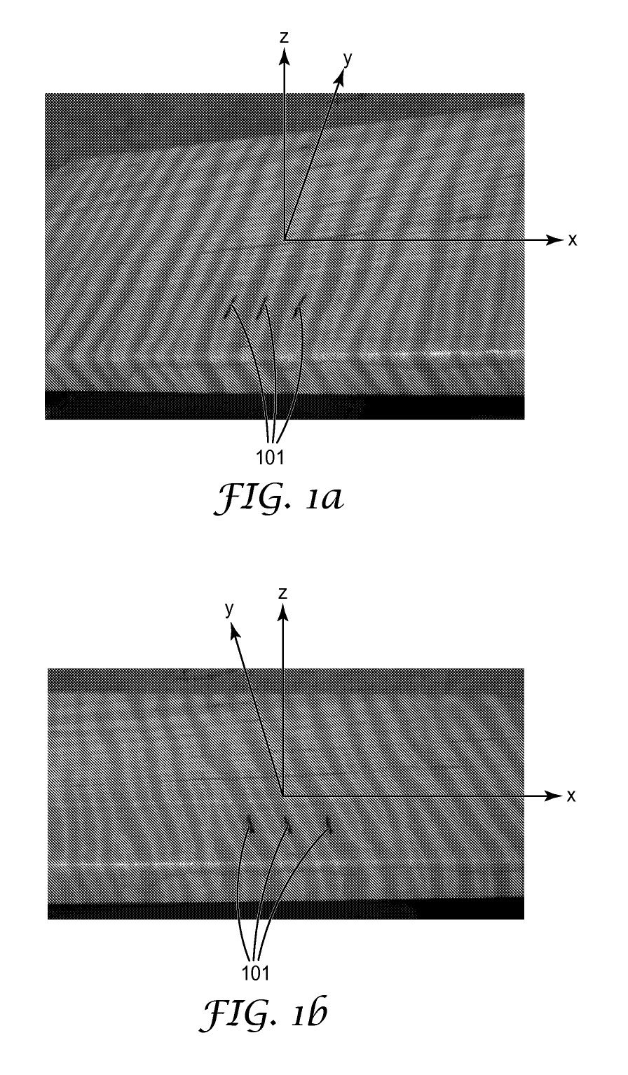

For clarity and to avoid confusion, the word “figure” is italicized in this document when referring to the characteristic of wood described above, and is not italicized when referring to the drawings, e.g. FIG. 1a, 1b, and so forth.

Flame maple and flame birch are examples of wood that are highly figured. The 3-dimensional shifting visual effect is exemplified in connection with FIGS. 1a and 1b. Those figures are photographs of a polished piece of flame maple, also sometimes referred to as flamed maple, tiger maple, or fiddleback maple, on which a Cartesian x, y, z coordinate system has been superimposed. A pen was used to place three fixed reference marks 101 on the surface of the wood. Each of the reference marks 101 extends generally parallel to the y-axis, which also coincides with a width axis of the wood. The x-axis coincides with a length axis of the wood. For the particular piece of wood shown, the wood grain can be seen to have a slight curvature (i.e. the individual narrow wood grain features are not precisely straight along their entire lengths) and can also be seen to be roughly aligned or parallel to the x-axis. A set of wider stripes can also be seen in the photographs, each of the wide stripes extending roughly parallel to the y-axis, i.e., roughly perpendicular to the grain of the wood. The wide stripes are associated with the figure of the piece of wood shown. These stripes are arranged in an alternating bright/dark pattern.

FIGS. 1a and 1b depict the same piece of flame maple under identical lighting conditions. The only difference between FIGS. 1a and 1b is the position and orientation of the camera, i.e., the position and orientation of the observer. The camera position changes from having a positive x-coordinate in FIG. 1a to having a negative x-coordinate in FIG. 1b. This change in position along the x-axis produces a shift in the pattern of wide stripes. In FIG. 1a, the reference marks 101 coincide with three of the bright wide stripes. In FIG. 1b, the same reference marks 101 coincide with three of the dark wide stripes. Thus, as the observer moves along the x-axis in relation to the piece of wood, the stripes or markings associated with the figure appear to shift across the surface of the wood (along the x-axis), such that the stripes and the piece of wood have a 3-dimensional appearance.

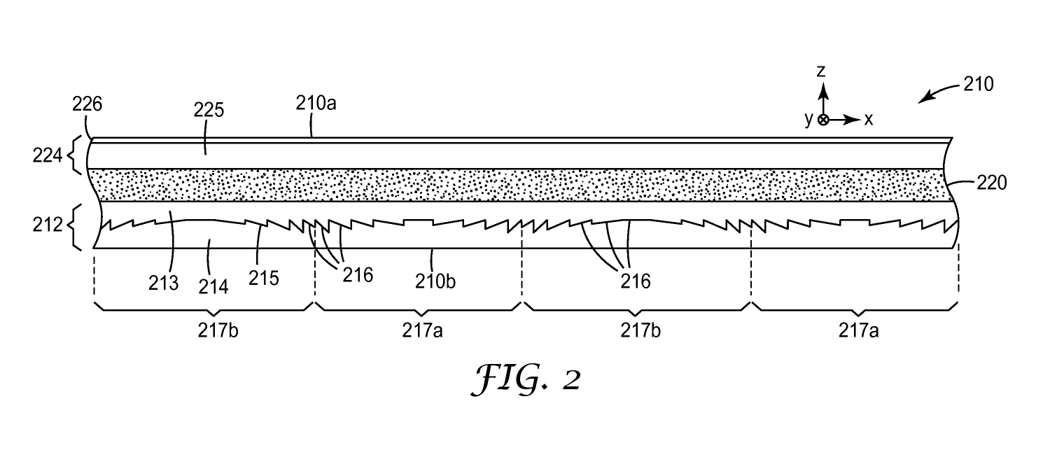

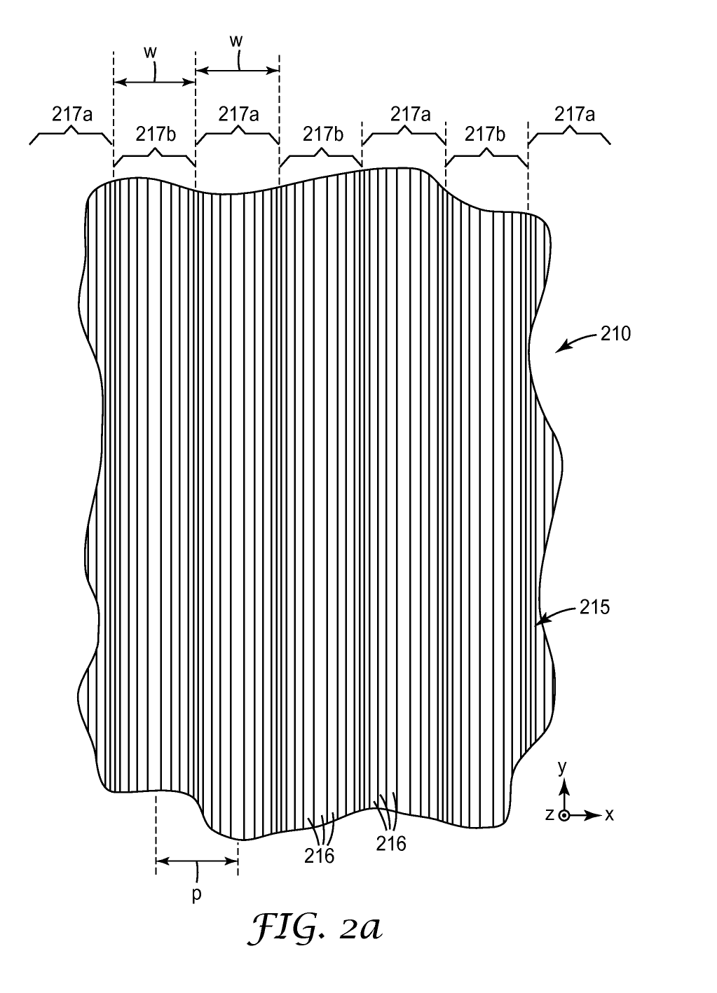

We have found that Fresnel mirror films, when properly designed and when combined with other suitable components, can produce film articles having the 3-dimensional appearance of highly figured wood such as that depicted in FIGS. 1a and 1b. We describe such articles in connection with at least FIGS. 2 through 8b.

In FIG. 2, a film article 210 is made up of constituent components that can be tailored to provide the article 210 with a 3-dimensional wood-like appearance. The article includes a first film 212, a diffuser in the form of a diffuser layer 220, and an indicia layer 224. Some or all of the layers may be polymer-based such that the article, or one or more components thereof, can be manufactured on a conventional film line with conventional polymer base materials. Alternatively or in addition, the article can be made with other known processes and equipment, and may comprise non-polymeric materials, such as glasses, ceramics, metals, and/or other suitable materials. Further discussion of materials is provided below.

The article 210 has a front major surface 210a and a back major surface 210b. The first film 212, located at or near the back surface 210b, includes a first layer 213 and a second layer 214. An interface 215 between these layers is configured as a faceted surface with individual facets 216. The faceted surface can be considered a type of structured surface. The facets 216 are reflective, or they may be transmissive and in close proximity to a separate reflector, as discussed further below. The facets 216 are typically substantially flat or planar, and are oriented at a variety of different angles and arranged in a particular sequence, referred to as a slope sequence, such that they collectively form two types of Fresnel mirrors: focusing Fresnel mirrors 217a, and defocusing Fresnel mirrors 217b. In FIG. 2, these Fresnel mirrors 217a, 217b are contiguous with each other and arranged in an alternating sequence, but other configurations are also contemplated as explained further below. The focusing properties of Fresnel mirror 217a and the defocusing properties of Fresnel mirror 217b are a result of the configuration of facets 216 shown in FIG. 2, in combination with the assumption that light impinges on the interface 215 from above (through surface 210a), from the perspective of FIG. 2.

Either one of the layers 213, 214 may be embossed or cast against a suitable structured tool to impart the desired geometry of the faceted interface 215, and the other layer (213 or 214) may be added or coated on later as a planarization layer. For example, in some cases the layer 214 may be formed first by embossing or casting the layer against a structured tool to provide a structured surface, followed by planarizing the layer 214 with the layer 213 such that the structured surface becomes the faceted interface 215. Alternatively, the layer 213 may first be embossed or cast to provide a structured surface, and later the layer 214 may be added as a planarization layer so that the structured surface again becomes the faceted interface 215. In either case, the facets 216 of the interface 215 may be made reflective by applying a reflective material such as a thin coating of aluminum, silver, or other reflective metal or other material to the structured surface of the embossed or cast layer before planarization. If the facets 216 are reflective, the second layer 214 need not be light transmissive, e.g., the layer 214 may be opaque. The first layer 213, however, is preferably clear or otherwise suitably light transmissive so that incident light can propagate from the front surface 210a to the interface 215, and so that reflected light can propagate from the interface back towards and through the front surface to the eye of the observer.

The article 210 is depicted in the context of a Cartesian x,y,z coordinate system. Preferably, the facets 216 and the Fresnel mirrors 217a, 217b are linear or otherwise elongated along the y-direction, i.e., they extend along an axis perpendicular to the plane of the drawing. This is shown in the plan view of the Fresnel mirrors 217a, 217b provided in FIG. 2a. The facets 216 and the Fresnel mirrors, which are contiguous to each other with substantially no intervening space or land area in between, can each be seen to extend along the y-axis. Such an orientation is consistent with that of the wide bright and dark stripes in FIGS. 1a and 1b, which are likewise oriented parallel to the y-axis. In the film article 210, the Fresnel mirrors 217a, 217b take the place of the wood figure, and are responsible for producing bright and dark bands, as well as providing a 3-dimensional look to the article. The Fresnel mirrors may each be characterized by a plan view width “w” as shown in FIG. 2a. The pattern of Fresnel mirrors may also be characterized by a plan view center-to-center pitch “p”, also shown in FIG. 2a. For contiguous Fresnel mirrors of uniform width, w=p.

The article 210 also includes a diffuser disposed to scatter light reflected by the Fresnel mirrors. From a visual standpoint, the diffuser has the effect of softening or dulling the reflections from the Fresnel mirrors to avoid an overly harsh metallic-looking appearance. The diffuser of FIG. 2 is in the form of a distinct diffuser layer 220, attached to the first film 212. The diffuser layer 220 may for example be or comprise a layer of light transmissive matrix material within which is dispersed particles and/or voids to promote scattering of visible light. Suitable particles may include transparent microbeads of suitable size distribution and having a higher or lower refractive index at visible wavelengths than that of the matrix material.

The diffuser preferably diffuses or scatters light neither too much nor too little, but to an intermediate degree. If the diffuser scatters light too much, the focusing or defocusing characteristics of the Fresnel mirrors will be obliterated, thus eliminating the 3-dimensional appearance of the article. If instead the diffuser scatters light too little, an undesirable overly harsh metallic-looking appearance may result. Light scattering can be characterized by quantities known as haze, transmission, and clarity. For light that is normally incident on an article, film, or layer, the haze may, unless otherwise indicated, refer to the ratio of the transmitted light that deviates from the normal direction by more than 4 degrees to the total transmitted light. The optical haze value can be measured by any suitable means, e.g., using a Haze-Gard Plus haze meter, available from BYK-Gardner, Columbia, Md. We have found that for isotropic diffusers, a haze level in a range from 0 to 90%, more preferably 50% to 80%, provides an appropriate amount of light diffusion in typical cases. If light diffusion is provided by a separate layer, the transmission of such a layer is preferably greater than 50% over some or all of the visible light spectrum. The clarity of a diffuser is often not critical for films or layers that are in contact or close proximity to each other, and thus may be tailored as desired, or left unspecified.

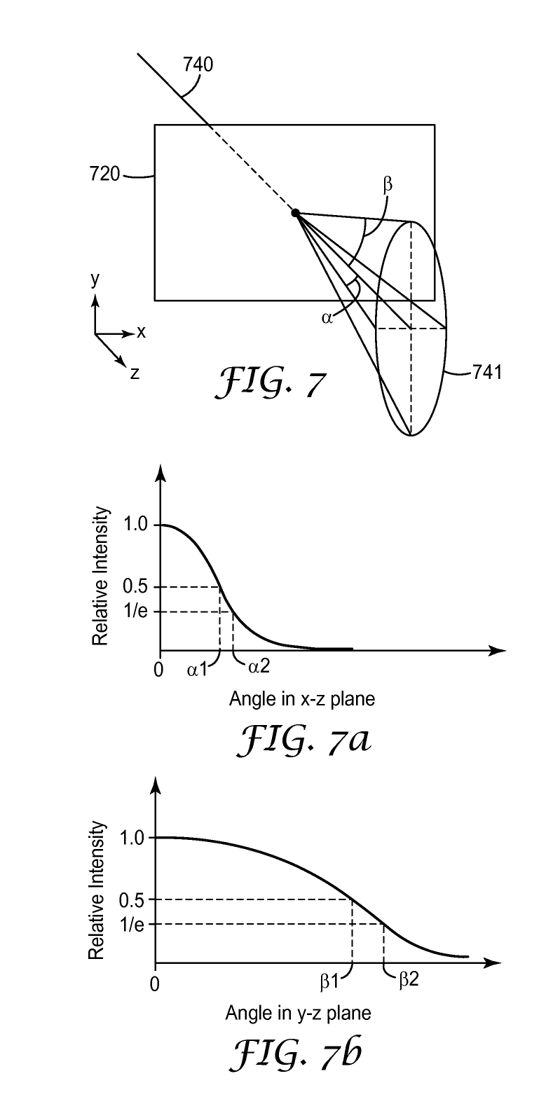

We have also found that asymmetric diffusers can be used with particular benefit in cases where the Fresnel mirrors are elongated along a given in-plane axis. An “asymmetric diffuser” in this regard refers to a diffuser that does not scatter normally incident light equally along all in-plane directions, but scatters such light preferentially along a given in-plane direction relative to other in-plane directions. For example, in FIG. 2, each of the Fresnel mirrors 217a, 217b extends along a direction parallel to the y-axis. In this case it is desirable for the diffuser layer 220 to diffuse normally incident light, which propagates along the negative z-direction, preferentially along the y-axis. That is, for light that is normally incident on the surface 210a, the diffuser layer 220 preferentially scatters that light to a greater degree in the y-z plane than in the x-z plane. The rationale for this is that the focusing and defocusing action of the elongated Fresnel mirrors 217a, 217b occurs primarily or exclusively in the x-z plane rather than in the y-z plane, and thus, much more scattering can be tolerated in the y-z plane than in the x-z plane while still retaining the focusing and defocusing characteristics that provide the 3-dimensional appearance. Further discussion of asymmetric diffusers is provided below in connection with FIG. 7.

The article 210 also includes an indicia layer 224. The layer 224 may be or comprise a base film 225 to which a coating 226 of ink or other suitable material has been printed or otherwise applied to form indicia. The indicia layer 224 is disposed to cover the diffuser layer 220 and the first film 212. Like the diffuser layer 220, the indicia layer 224 is arranged to intercept light that is reflected by the Fresnel mirrors in the first film 212.

If the article 210 is to have a wood-like appearance, the indicia layer 224 preferably provides indicia shaped like wood grain. The wood grain indicia may be provided on a colored background, for example, a brown transparent background suggestive of wood. As we saw in the actual photographs of FIGS. 1a and 1b, wood grain may extend along an in-plane axis that is roughly perpendicular to an in-plane axis of elongation of the stripes associated with the wood figure. Therefore, the wood grain of indicia layer 224 may be oriented to extend along the x-axis, perpendicular to the axis of elongation of the Fresnel mirrors 217a, 217b, so as to produce a realistic 3-dimensional appearance of a highly figured wood.

The 3-dimensional visual effect provided by the Fresnel mirrors in the article 210 can be more easily explained by considering an article that is in all respects the same as article 210, except that the Fresnel mirrors are replaced with corresponding bulk (non-Fresnel) mirrors. If such a replacement is made, the result is the article 210′ shown schematically in FIG. 2b. Components of article 210′ that are identical to corresponding components of article 210 are labeled with the same reference number and merit no further discussion. The film 212 in FIG. 2 is replaced by film 212′ in FIG. 2b, and the constituent first and second layers 213, 214 are replaced by first and second layers 213′, 214′, which are necessarily thicker than their counterparts 213, 214. The facets 216 are replaced by facets 216′. Facets 216′ are oriented at the same angles and have the same slope sequence as their respective counterparts 216, but they are individually translated parallel to the z-axis by amounts that ensure that the endpoints of neighboring facets coincide, with no vertical wall therebetween as is characteristic of Fresnel structures. This linear translation produces a continuous sequence of facets 216′ which forms a modified interface 215′ between the first and second layers 213′, 214′. Therefore, just as with the facets 216, the facets 216′ produce an alternating arrangement of contiguous focusing mirrors 217a′ and defocusing mirrors 217b′, each of these mirrors extending parallel to the y-axis similar to the depiction of FIG. 2a.

From a physical standpoint, the article 210′ is substantially thicker, and hence also in general more bulky, more massive, more rigid, and less flexible, than the article 210. However, from a geometrical optics standpoint, the article 210′ is substantially the same as article 210, because the reflective facets 216′ of interface 215′ behave in substantially the same way as the facets 216 of interface 215, and vice versa. (For purposes of this discussion we presume the facets 216′ are highly reflective, e.g., by the application of a thin reflective coating such as aluminum, silver, or a multilayer dielectric stack, at the interface 215′.)

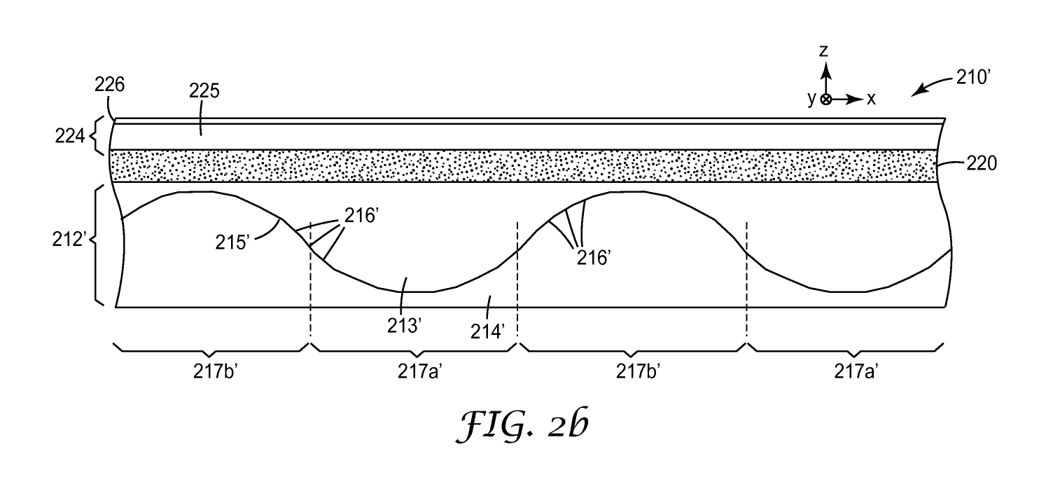

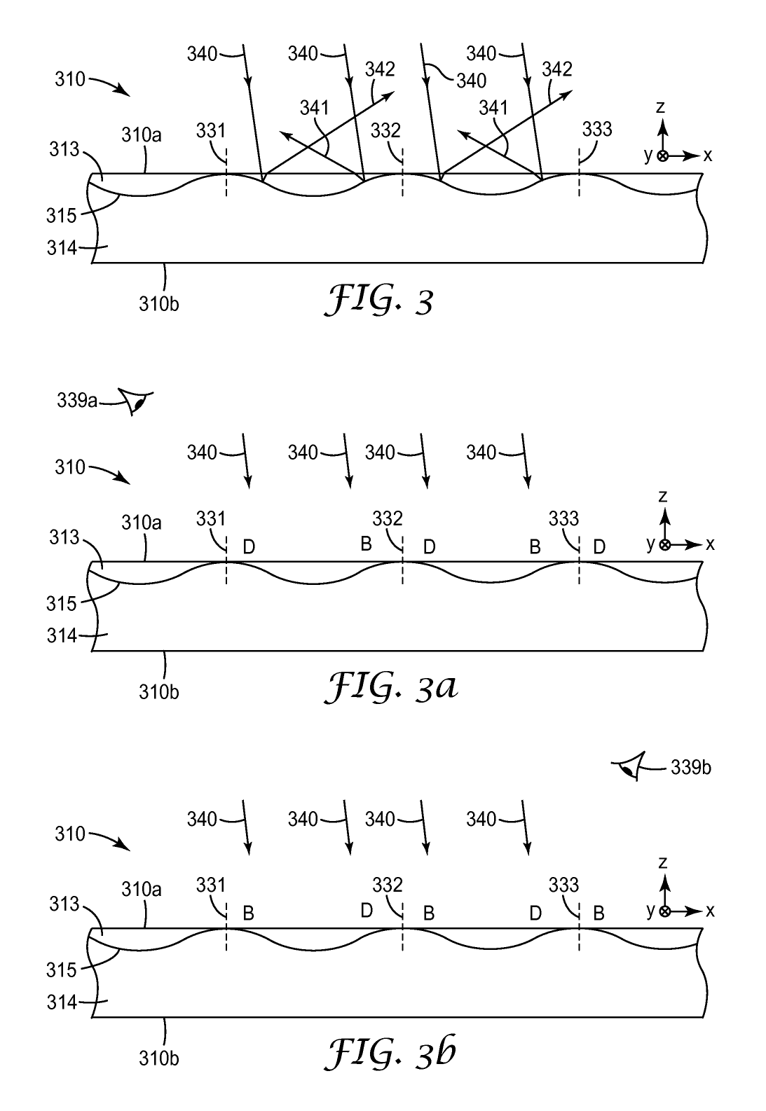

The dynamic, 3-dimensional appearance provided by the arrangement of focusing and defocusing mirrors is discussed in connection with FIGS. 3, 3a, and 3b. The article 310 of these figures may be similar or identical to the article 210′ of FIG. 2b, except that the diffuser layer 220 and the indicia layer 224 are omitted from article 310 for simplicity and ease of discussion.

Thus, in FIG. 3 we see an article 310 having a front major surface 310a and a back major surface 310b. The article 310 is made up of a first layer 313 and a second layer 314. An interface 315 between these layers, which interface is assumed to be highly reflective, is configured as an undulating bulk mirror. The undulating mirror can alternatively be considered to be an alternating arrangement of contiguous focusing and defocusing mirrors, which are not labeled in FIG. 3 but are substantially as shown previously in FIG. 2b. The interface 315 may be faceted, i.e., composed of an arrangement of flat facets as shown in FIG. 2b, or the flat facets may be smoothed out to form a sinusoid or similar smooth curve that undulates as shown. The interface 315, as well as the layers 313 and 314, extends linearly along the y-direction in an analogous fashion to FIG. 2a. Reference marks 331, 332, 333 are provided in FIGS. 3, 3a, and 3b to identify locations of the local maxima of the interface 315, which locations are fixed in relation to the surface 310a.

Incident light 340 is assumed to impinge on the front surface 310a of the article from a particular direction of choice. This direction of the incident light 340 is assumed to be the same in FIGS. 3, 3a, and 3b. The incident light encounters the front surface 310a and refracts into the first layer 313. The amount of refraction depends on the refractive indices of the media on opposite sides of the surface 310a, i.e., the refractive index of the first layer 313, and the refractive index of the surrounding medium, which in this case is typically air. The light then propagates through the layer 313, which is optically clear or otherwise light transmissive, and reaches the reflective interface 315. There, it is reflected in various directions. After reflection at the interface 315, the light is transmitted back through the layer 313, refracts at the front surface 310a, and propagates onward into the surrounding medium.

The direction of the reflected light depends on the direction of incidence, which is assumed to be uniform across the entire surface 310a, and on the local slope of the interface 315, which varies as one evaluates different points on the surface 310a. For example, in the region from reference mark 331 to reference mark 332, the slope ranges from a zero slope at reference mark 331, to increasingly negative slopes, to a maximum negative slope (occurring about one-fourth of the way from mark 331 to mark 332), to diminishing negative slopes, to a zero slope (occurring about one-half of the way from mark 331 to mark 332), to increasingly positive slopes, to a maximum positive slope (occurring about three-fourths of the way from mark 331 to mark 332), to diminishing positive slopes, to a zero slope at reference mark 332. (Note that other descriptions of this slope sequence are also possible by shifting the evaluation region, e.g., the slope sequence can be described as ranging from a first zero slope to increasingly positive slopes to a maximum positive slope to diminishing positive slopes to a second zero slope to increasingly negative slopes to a maximum negative slope to diminishing negative slopes to the first zero slope. A “zero slope” need not be precisely horizontal but may be within a few degrees of horizontal.) Due to the repetitive nature of the shape of the interface 315, this slope sequence repeats in a substantially uninterrupted fashion across the interface 315. Two rays of the incident light 340 that strike local portions of the interface 315 having a positive slope are shown to be reflected as reflected rays 341, which travel generally to the left as seen from the perspective of FIG. 3. Two other rays of the incident light 340 strike local portions of the interface 315 having a negative slope, and these rays are shown to be reflected as reflected rays 342, which travel generally to the right as seen from the perspective of FIG. 3.

FIGS. 3a and 3b illustrate how the article 310, when illuminated as shown in FIG. 3 with incident light 340, appears to an observer who shifts from one viewing geometry to another. In FIG. 3a, an observer 339a is located as shown relative to the article, generally to the left of central reference mark 332. In FIG. 3b, an observer 339b is located as shown relative to the article, generally to the right of central reference mark 332. In the viewing orientation of FIG. 3a, the observer 339a is positioned to intercept and thus perceive reflected light rays such as reflected rays 341 (see FIG. 3), but is not positioned to intercept or perceive reflected light rays such as reflected rays 342 (see FIG. 3). As a result, the observer 339a perceives a pattern of alternating bright and dark stripes, bands, or other markings at or near the surface 310a, the pattern being labeled in FIG. 3a with a “B” for a relatively bright stripe or feature (as a result of perceiving rays such as reflected rays 341) and with a “D” for a relatively dark stripe or feature (as a result of not perceiving rays such as reflected rays 342). In the shifted viewing orientation of FIG. 3b, the observer 339b is positioned to intercept and thus perceive reflected light rays such as reflected rays 342, but is not positioned to intercept or perceive reflected light rays such as reflected rays 341. As a result, the observer 339b perceives a pattern of alternating bright and dark stripes, bands, or other markings at or near the surface 310a, the pattern being labeled in FIG. 3b with a “B” for a relatively bright stripe or feature (as a result of perceiving rays such as reflected rays 342) and with a “D” for a relatively dark stripe or feature (as a result of not perceiving rays such as reflected rays 341).

Comparison of FIGS. 3a and 3b demonstrates how the undulating reflective interface 315 provides the article 310 with a pattern of bright and dark features that appear to move or shift relative to fixed reference positions on the surface of the article, as the position and orientation of the observer changes. A similar analysis can be done to show that the perceived pattern of bright and dark features also move or shift if the observer remains stationary and the position of the light source, or the direction of the incident light, changes. In either case, the visual characteristic of a pattern of features that move or shift relative to the surface of the article with viewing and/or illumination geometry, gives the article a 3-dimensional appearance. This 3-dimensional visual characteristic is also provided by the articles of FIGS. 2 and 2b, provided the focusing and defocusing properties of the mirrors are not unduly obscured by the diffuser or the indicia layer.

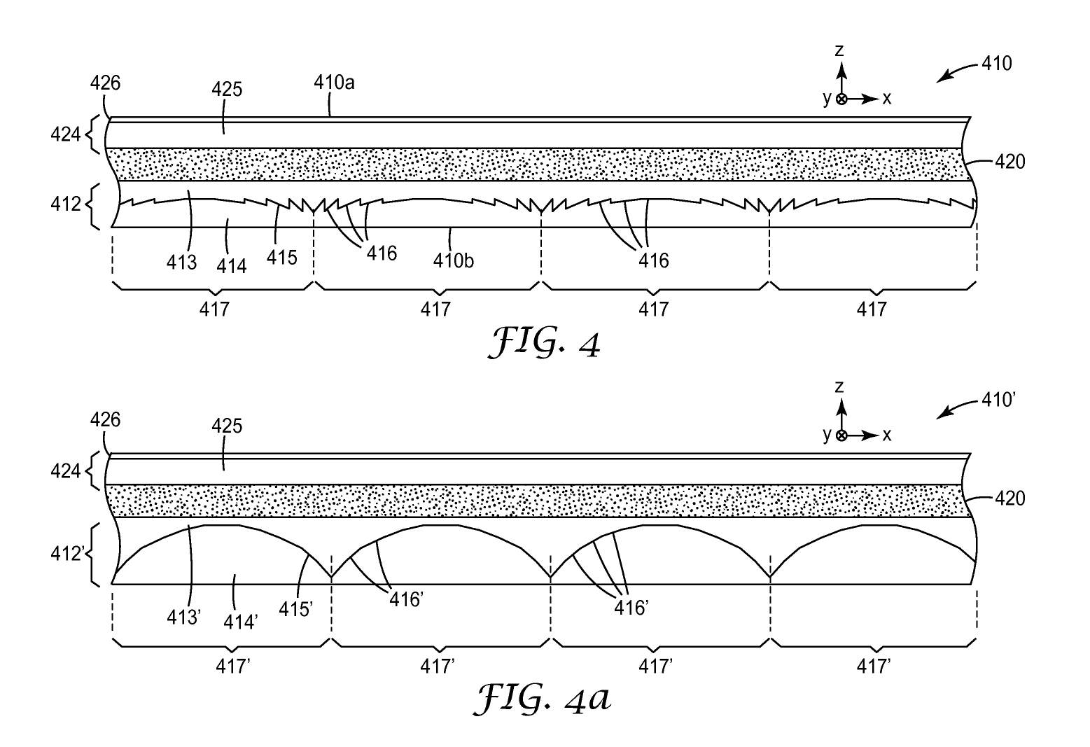

In FIG. 4, we schematically illustrate another film article 410 whose constituent components can be tailored to provide the article 410 with a 3-dimensional wood-like appearance. The article 410 has a construction that is similar to that of article 210, except that the arrangement of Fresnel mirrors is different. In particular, rather than an alternating arrangement of contiguous focusing Fresnel mirrors and defocusing Fresnel mirrors, as was used in article 210, the article 410 uses only defocusing Fresnel mirrors. They are also arranged contiguously.

Other than the change in the Fresnel mirror design, the components of article 410 may be similar to, or the same as, corresponding components of article 210. Thus, for example, article 410, which has a front major surface 410a and a back major surface 410b, includes an indicia layer 424 having a base film 425 and a coating 426, which may be the same as or similar to indicia layer 224, base film 225, and coating 226, respectively. For example, the indicia layer 424 preferably provides indicia shaped like wood grain if the article 410 is to have a wood-like appearance. Article 410 also includes a diffuser in the form of a distinct diffuser layer 420, which may be the same as or similar to diffuser layer 220. The diffuser layer 420 may be an asymmetric diffuser, particularly in cases where the Fresnel mirrors are elongated along an in-plane axis, as discussed in connection with article 220.

Article 410 also includes a first film 412 located at or near the back surface 410b, the first film 412 including a first layer 413 and a second layer 414, between which an interface 415 is configured as a faceted surface with individual facets 416. The first film 412, first and second layers 413, 414, and facets 416 may be the same as or similar to first film 212, first and second layers 213, 214, and facets 216, respectively, except that the orientation or slope sequence of the facets 416 is different from that of facets 216 so as to form an arrangement of contiguous defocusing Fresnel mirrors 417. The facets 416 are reflective, or they may be transmissive and in close proximity to a separate reflector. The facets 416 and Fresnel mirrors 417 are preferably substantially linear and elongated along the y-axis, such that a plan view of the interface 415 and Fresnel mirrors 417 may be identical or similar to FIG. 2a.

In order to enhance the reader's understanding of the film article 410, we show in FIG. 4a a similar article containing only bulk mirrors. FIG. 4a is a schematic side- or cross-sectional view of an article 410′ that is in all respects the same as article 410, except that the Fresnel mirrors are replaced with corresponding bulk (non-Fresnel) mirrors. Components of article 410′ that are identical to corresponding components of article 410 are labeled with the same reference number and merit no further discussion. The film 412 in FIG. 4 is replaced by film 412′ in FIG. 4a, and the constituent first and second layers 413, 414 are replaced by first and second layers 413′, 414′, which are necessarily thicker than their counterparts 413, 414. The facets 416 are replaced by reflective facets 416′. Facets 416′ are oriented at the same angles and have the same slope sequence as their respective counterparts 416, but they are individually translated parallel to the z-axis by amounts that ensure that the endpoints of neighboring facets coincide, with no vertical wall therebetween as is characteristic of Fresnel structures. This linear translation produces a continuous sequence of facets 416′ which forms a modified reflective interface 415′ between the first and second layers 413′, 414′. Therefore, just as with the facets 416, the facets 416′ produce an arrangement of contiguous defocusing mirrors 417′, each of these mirrors extending parallel to the y-axis similar to the depiction of FIG. 2a.

Even though the article 410 does not contain any focusing Fresnel mirrors, the defocusing properties of the Fresnel mirrors 417 still produce a pattern of bright and dark stripes or other markings that appear to move or shift relative to fixed reference positions on the surface of the article, as the position and orientation of the observer and/or the direction of the incident light changes. The visual characteristic of a pattern of features that move or shift relative to the surface of the article with viewing and/or illumination geometry gives the article 410 a dynamic, 3-dimensional appearance.

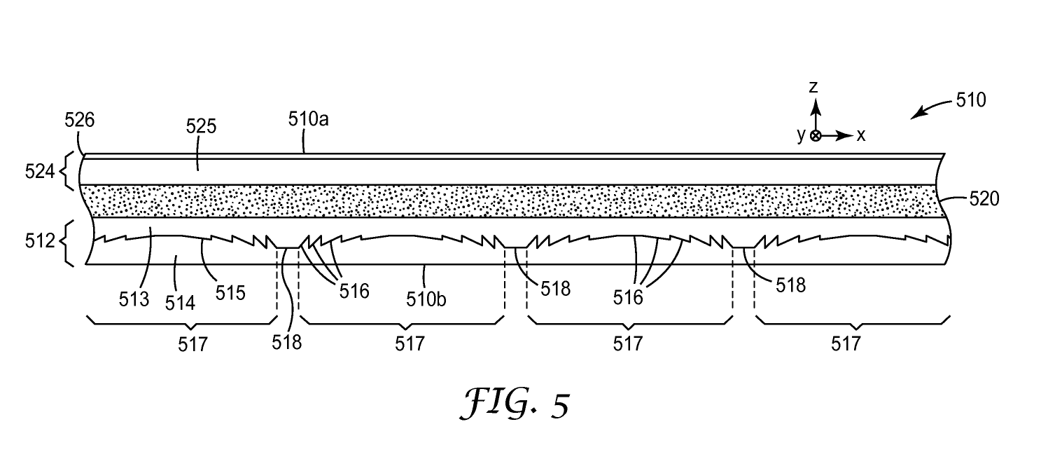

In FIG. 5, we schematically illustrate another film article 510 whose constituent components can be tailored to provide the article 510 with a 3-dimensional wood-like appearance. The article 510 has a construction that is similar to that of article 410, except that the arrangement of Fresnel mirrors is different. In particular, rather than an arrangement of contiguous defocusing Fresnel mirrors, as was used in article 410, the article 510 separates the defocusing Fresnel mirrors from each other.

Other than the change in the Fresnel mirror arrangement, the components of article 510 may be similar to, or the same as, corresponding components of article 410. Thus, for example, article 510, which has a front major surface 510a and a back major surface 510b, includes an indicia layer 524 having a base film 525 and a coating 526, which may be the same as or similar to indicia layer 424, base film 425, and coating 426, respectively. For example, the indicia layer 524 preferably provides indicia shaped like wood grain if the article 510 is to have a wood-like appearance. Article 510 also includes a diffuser in the form of a distinct diffuser layer 520, which may be the same as or similar to diffuser layer 420. The diffuser layer 520 may be an asymmetric diffuser, particularly in cases where the Fresnel mirrors are elongated along an in-plane axis, as discussed in connection with article 220.

Article 510 also includes a first film 512 located at or near the back surface 510b, the first film 512 including a first layer 513 and a second layer 514, between which an interface 515 is configured as a faceted surface with individual facets 516, 518. The first film 512, first and second layers 513, 514, and facets 516 may be the same as or similar to first film 412, first and second layers 413, 414, and facets 416, respectively. In the interface 515, facets 518 are included to provide a separation region between each pair of Fresnel mirrors. The facets 518 provide no substantial focusing or defocusing characteristics. In some cases, the facets 518 may be flat, or they may be textured or roughened to diffuse or scatter incident light. The facets 518 may be reflective, like the facets 516, or the facets 518 may be opaque, or transmissive if the second layer 514 is opaque or diffusely scattering. The facets 516, 518, and Fresnel mirrors 517 are preferably substantially linear and elongated along the y-axis. This is shown in the plan view of the interface 515 provided in FIG. 5a. The facets 516, 518 and the Fresnel mirrors 517, which are separated from each other by separation regions provided by facets 518, can each be seen to extend along the y-axis. Such an orientation is consistent with that of the wide bright and dark stripes in FIGS. 1a and 1b, which are likewise oriented parallel to the y-axis. In the film article 510, the Fresnel mirrors 517 take the place of the wood figure, and are responsible for producing bright and dark bands, as well as providing a 3-dimensional look to the article. The Fresnel mirrors may each be characterized by a plan view width “w1” as shown in FIG. 5a, and the separation regions may be characterized by a plan view width “w2”. The values of w1 and w2 may be chosen by the film designer to provide a suitable visual appearance in the finished article. In some cases, w1 may be less than w2. In other cases, w1 may substantially equal w2. In still other cases, w1 may be greater than w2. The pattern of Fresnel mirrors can also be characterized by a plan view center-to-center pitch “p”, also shown in FIG. 5a. For these non-contiguous Fresnel mirrors of uniform width, p=w1+w2. The facets 518 may be smooth and highly transparent or they may be roughened or coated to provide a diffuse stripe in the film, or they may be coated or printed with pigmented or dyed colored inks An individual facet may be continuous or discontinuous along the length of the film and the diffuser or printed and colored coatings on a facet may be continuous or discontinuous. Some or all of the facets 518 may be treated in this manner.

In order to enhance the reader's understanding of the film article 510, we show in FIG. 5b a similar article containing only bulk mirrors. FIG. 5b is a schematic side- or cross-sectional view of an article 510′ that is in all respects the same as article 510, except that the Fresnel mirrors are replaced with corresponding bulk (non-Fresnel) mirrors. Components of article 510′ that are identical to corresponding components of article 510 are labeled with the same reference number and merit no further discussion. The film 512 in FIG. 5 is replaced by film 512′ in FIG. 5a, and the constituent first and second layers 513, 514 are replaced by first and second layers 513′, 514′, which are necessarily thicker than their counterparts 513, 514. The facets 518, 516 are replaced by facets 518′and reflective facets 516′, respectively. Facets 516′, 518′ are oriented at the same angles and have the same slope sequence as their respective counterparts 516, 518, but they are individually translated parallel to the z-axis by amounts that ensure that the endpoints of neighboring facets coincide, with no vertical wall therebetween as is characteristic of Fresnel structures. This linear translation produces a continuous sequence of facets 516′, 518′ which forms a modified reflective interface 515′ between the first and second layers 513′, 514′. Therefore, just as with the facets 516, the facets 516′ produce an arrangement of defocusing mirrors 517′, each of these mirrors extending parallel to the y-axis similar to the depiction of FIG. 5a.

Even though the article 510 does not contain any focusing Fresnel mirrors, the defocusing properties of the Fresnel mirrors 517 still produce a pattern of bright and dark stripes or other markings that appear to move or shift relative to fixed reference positions on the surface of the article, as the position and orientation of the observer and/or the direction of the incident light changes. The visual characteristic of a pattern of features that move or shift relative to the surface of the article with viewing and/or illumination geometry gives the article 510 a dynamic, 3-dimensional appearance.

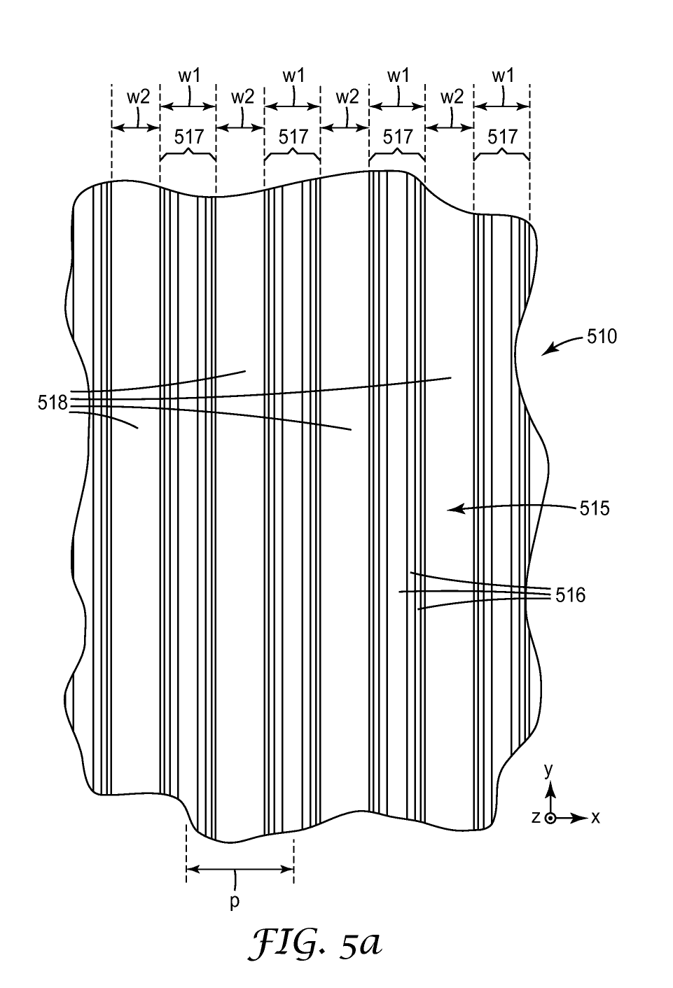

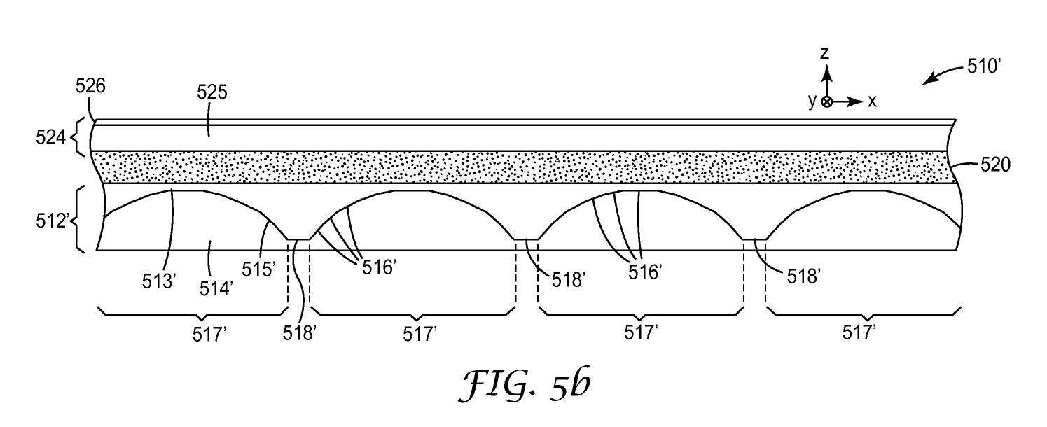

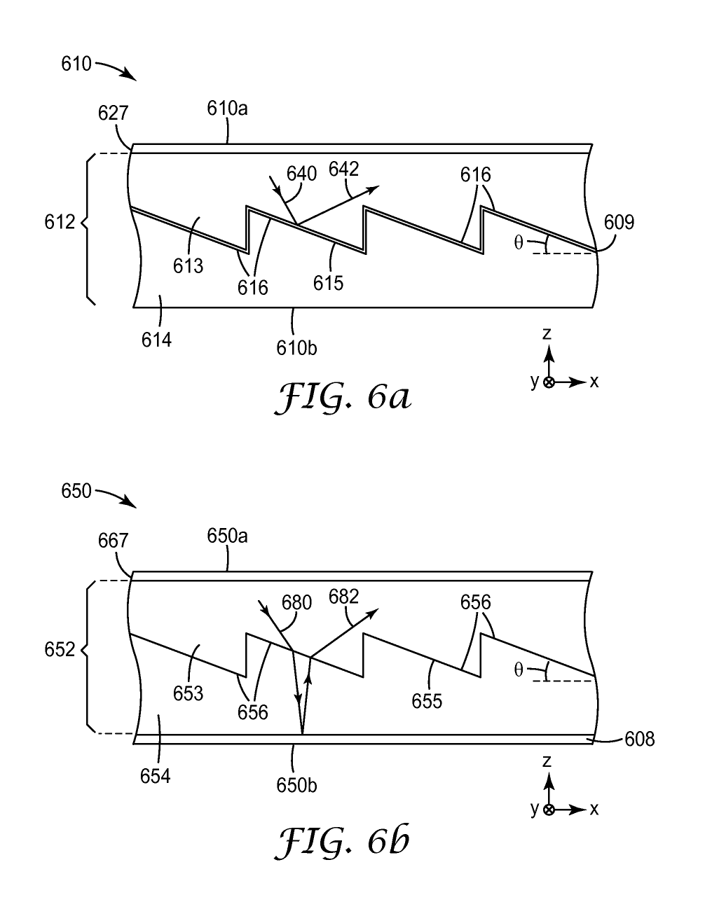

As mentioned above in connection with FIGS. 2, 4, and 5, the facets of the Fresnel mirrors may be reflective, such as if a thin coating of aluminum, silver, or other reflective metal or dielectric stack is applied to the facets, or they may be transmissive and in close proximity to a separate reflector. These two construction configurations are depicted in FIGS. 6a and 6b. In FIG. 6a, an article 610 uses reflective facets, and in FIG. 6b, an article 650 uses transmissive facets in combination with a nearby flat reflector.

The article 610 of FIG. 6a has a front major surface 610a, through which incident light enters and reflected light exits, and a back major surface 610b. Also included is a first film 612 located at or near the back surface 610b, the first film 612 including a first layer 613 and a second layer 614, between which an interface 615 is configured as a faceted surface with individual facets 616. Each facet may be characterized by an orientation or slope given by an angle 0 with respect to the plane of the film (the x-y plane) or with respect to another suitable reference plane. The view of FIG. 6a shows only a small portion of one Fresnel mirror, and, since neighboring facets may have similar orientations (or even the same orientation, for small groups of neighboring facets), the facets 616 are shown in the figure to have about the same inclination angle θ. Attached to a front side of the film 612 is a light-transmissive functional layer 627. The layer 627 may possess any of a number of desirable optical and/or physical properties to enhance the functionality of the article 610. For example, if the article 610 is to have a 3-dimensional wood-like appearance, the layer 627 may provide a suitable amount and type of light diffusion, and it may also provide suitable printed indicia. The layer 627 may also provide desirable physical properties such as a scratch-resistant hard coat.

A thin reflective coating 609 is disposed at the interface 615, on the facets 616 and also optionally on the vertical (or near-vertical) sidewalls that connect adjacent facets. The coating may be or include a thin coating of aluminum, silver, nickel, chromium, or other reflective metal, or a dielectric stack coating. Preferably, the coating 609 has an average reflectivity over the visible light spectrum of at least 30%, or at least 50, 60, 70, 80, 90, or 95%, although lower reflectivites can also produce useful results. With this coating, the facets 616 reflect light, as demonstrated by light ray 640 being reflected at one of the facets 616 as reflected light ray 642. Coatings of a single layer of high index transparent material, e.g. refractive index n>2, can provide a moderate reflectivity with high transmission since the transparent material can have very low absorption of light. For example, a thin layer of titanium dioxide on the facets 616 can have a reflectivity greater than 10% if one of the films 613 or 614 has a refractive index of n≦1.20. Thin dielectric layers can provide a good approximation to the rule that % Transmission=100−% Reflection. Thin metal layers typically have at least 10% absorption, but can have 20% or 30% absorption, or more. A thin transparent layer can be a quarter wave thick for low color, or a higher multiple of a quarter wave for colored reflections. When the coating 609 is partially transmissive, the article 610 can appear as a Fresnel mirror with a 3D-like surface while simultaneously transmitting useful light with a privacy feature such that the details of objects or personnel cannot be recognized. Stated differently, the article 610 can function simultaneously as both a Fresnel mirror and a Fresnel lens if the coating 609 is partially reflective and partially transmissive. However, if desired, the lensing effect for transmitted light in such embodiments can be eliminated (while retaining the Fresnel mirror effect due to the partial reflectivity of the facets) by selecting materials for the layers 613 and 614 that have the same or similar refractive indices, e.g. where the difference in refractive index between these layers is less than 0.1, and ensuring that the coating 609 is much thinner than the average prism height such that the coating 609 does not planarize the prism structure.

Ray 642 can undergo total internal reflection (TIR) at the surface 610a, depending on the incidence angle of ray 640 and the refractive index of layer 613. TIR can result in an enhancement of the bright and dark bands in the wood figure. For this reason, the choice of which materials to use for layers 613 and 614 (which determines what refractive indices these layers will have) has visual consequences. In some embodiments, layer 613 or layer 614 can be an optically clear adhesive layer. Such adhesives typically have relatively low refractive indices, e.g., lower than that of some available UV curable polymers (n=1.58) and lower than that of zirconia nano-particle filled polymers (n=1.65) such as those used in prismatic brightness enhancement films (BEF). The refractive index of many optical adhesives is also lower than typical embossable films, such as polycarbonate (n=1.58). For this reason, it can be advantageous to make the front film 613 from an embossed or UV cured polymer, and make the layer 614 from an optical adhesive.

The article 650 of FIG. 6b has a front major surface 650a, through which incident light enters and reflected light exits, and a back major surface 650b. Also included is a first film 652 located near the back surface 650b, the first film 652 including a first layer 653 and a second layer 654, between which an interface 655 is configured as a faceted surface with individual facets 656. Each facet may be characterized by an orientation or slope given by an angle 0 with respect to the plane of the film (the x-y plane) or with respect to another suitable reference plane. The view of FIG. 6b shows only a small portion of one Fresnel mirror, and, since neighboring facets may have similar orientations (or even the same orientation, for small groups of neighboring facets), the facets 656 are shown in the figure to have about the same inclination angle θ. Attached to a front side of the film 652 is a light-transmissive functional layer 667. The layer 667 may be the same as or similar to the layer 627 of FIG. 6a.

As demonstrated by light ray 680, the facets 656 predominantly transmit rather than reflect visible light. Therefore, not only layer 653 but also layer 654 is adapted to be light-transmissive, and these two layers preferably differ in refractive index by greater than 0.1 and preferably as large as 0.4 or more. Refraction occurs at the facets 656 in accordance with the refractive indices of the respective layers 653, 654. A flat reflective layer 608 is provided at a back surface of the film 652. The reflective layer 608 reflects light back towards the facets 656, so that such light can pass back through the facets 656 (see e.g. light ray 682) and eventually emerge from the front surface 650a of the article 650. The article 650 has a more pronounced 3D appearance when the average distance from the interface 655 to the reflective layer 608 is much less than the focal length of the Fresnel lens. However, a 3D appearance is still observed at distances greater than the focal length of the Fresnel lens. To avoid ambiguity in the terminology used in this document, the combination of a Fresnel structured surface and a nearby reflective layer, such as that depicted schematically in FIG. 6b, can be considered to collectively constitute a Fresnel mirror if the distance from the reflective layer to the Fresnel structured surface is no more than half the focal length of the Fresnel structured surface, where “focal length” does not require diffraction-limited focusing performance but also encompasses focusing with substantial aberrations, in which case the focal length may be considered to be the distance from the Fresnel structured surface to the point at which a distant object, such as the sun, has its sharpest focus. On the other hand, if the distance from the reflective layer to the Fresnel structured surface is greater than half the focal length of the Fresnel structured surface, the combination can no longer be considered to collectively constitute a Fresnel mirror, but instead can be considered to be two distinct components: a Fresnel lens, and a reflective layer.

The layer 608 may be or comprise any suitably high reflectivity material or structure, such as aluminum, silver, or other reflective metal, or a dielectric stack such as 3M™ Vikuiti™ Enhanced Specular Reflector (ESR) Film. Preferably, the layer 608 has reflectivity over at least a portion of the visible light spectrum of at least 30%, or at least 50, 60, 70, 80, 90, or 95%. Narrow band color mirror films have been found to be particularly attractive in this construction. Narrow band mirrors have a transmission that is high (e.g. greater than 50%) when averaged over the visible spectrum, but a low transmission and high reflectivity (e.g. at least 30, 50, 60, 70, 80, 90, or 95% reflectivity) over a narrow spectral band in the visible, which can produce a colored flash, e.g. of blue, green, or red, at given observation angle. Angle-independent colors can be added to a Fresnel mirror by coating or laminating pigmented or dyed colored films onto the prisms or their substrate, or adding them to an existing laminate that includes the Fresnel mirror.

In cases where a reflective layer such as reflective coating 609 (FIG. 6a) or reflective layer 608 (FIG. 6b) has a high reflectivity over a portion of the visible spectrum and a low reflectivity and high transmission over another portion of the visible spectrum, the resulting construction, which can be referred to as a dichroic Fresnel mirror, functions as a Fresnel mirror for those visible wavelengths having a high reflectivity, and functions as a Fresnel lens for those visible wavelengths having a low reflectivity. Dichroic Fresnel mirrors are thus a class or subset of the larger group of Fresnel mirrors.

FIG. 7 depicts an exemplary diffuser 720 that can be used in the disclosed films. The diffuser 720 is an asymmetric diffuser, which means it does not scatter normally incident light equally along all in-plane directions. Instead, the diffuser 720 scatters a normally incident light beam 740 preferentially along a particular in-plane axis, which in this case is assumed to be the y-axis, although the axis of maximum scatter need not be precisely parallel to the axis of elongation of the Fresnel mirrors as discussed elsewhere herein. The diffuser 720 converts the incident beam 740 into a diffuse output beam 741 that is elongated along the y-axis. In this manner the diffuser scatters relatively little light in a given direction perpendicular to the Fresnel prism length axis, the given direction being that which gives the 3D perception. This permits the use of a diffuser of very high haze (e.g. 95% or even 99%) that does not mask the wave-like look of the film along the x-axis. By contrast, an isotropic diffuser having a haze of 99% would completely mask the 3D appearance of the film. The diffuse beam 741 may be characterized by a half angle α in the x-z plane, and a half angle β in the y-z plane. These half angles may be measured from a centroid or average direction of the diffuse beam 741 (which typically coincides with the direction of incidence of the incident beam 740) to an edge of the beam as specified in terms of a given relative intensity. The beam edge is explained better in FIGS. 7a and 7b. These figures show an idealized possible intensity distribution of a beam that has been scattered by the diffuser 720. The curves in FIGS. 7a and 7b plot the relative intensity of the scattered beam in the x-z plane and the y-z plane, respectively, as a function of angle relative to the z-axis or average direction of the scattered beam. The angles plotted in these figures thus correspond to the half-angles shown in FIG. 7. In FIG. 7a, the intensity drops from a maximum value (normalized to 1.0) to one-half of that value at an angle α1, and to 1/e of the maximum value (where e is the irrational number 2.718 . . . ) at an angle α2. In FIG. 7b, the intensity drops from a maximum value (normalized to 1.0) to one-half of that value at an angle β1, and to 1/e of the maximum value at an angle β2.

A common approach to defining beam size is to use the one-half of maximum criterion. Using this criterion, we see that β1>α1, i.e., the scattered beam is elongated along the y-axis. However, if we use the alternative 1/e criterion, we come to the same conclusion since β2>α2.

Numerous known asymmetric diffusers can be used in the construction of the disclosed articles. In a relatively low-cost embodiment, the diffuser may be made by extruding a blend of immiscible polymer resins that have different indices of refraction. Extrusion of the blend from a film die causes an elongation of the minor phase of the blend, resulting in a fiber-like or otherwise elongated internal structure. Polymer films can be made in this way to provide diffusion of light having any desired asymmetry, e.g., β1/α1 or β2/α2 can be made to be any desired value. In exemplary embodiments, β1/α1 and/or β2/α2 are at least 1.5, or at least 2, or at least 5, or at least 10. Furthermore, numerous known diffusers that exhibit no significant asymmetry (α1≈β1 and α2≈β2) can also be used in the disclosed articles. However, whether the diffuser is symmetric or asymmetric, in either case the diffuser preferably scatters light to such an extent that the 3-dimensional appearance provided by the focusing and/or defocusing properties of the Fresnel mirrors is maintained.

As mentioned above, when an asymmetric diffuser is used in articles that incorporate Fresnel mirrors that extend along a given in-plane axis, such as the constructions of FIGS. 2, 4, and 5, the diffuser is preferably oriented such that the axis of maximum diffusion is at least partially aligned with the axis of elongation of the Fresnel mirrors. With such an orientation, the article can be provided with more overall diffusion without eliminating, from the standpoint of a typical observer of the article, the unique appearance resulting from the focusing and/or defocusing characteristics of the Fresnel mirrors. Thus, if the Fresnel mirrors extend parallel to a first in-plane axis (such as the y-axis), and if the asymmetric diffuser diffuses light preferentially along a second in-plane axis, the first and second in-plane axes form an angle that is preferably less than 60, or 45, or 30, or 20, or 10, or 5 degrees. The angle formed by the first and second in-plane axes is desirably substantially zero degrees, i.e., the first and second in-plane axes are preferably substantially parallel, within manufacturing tolerances.

Numerous modifications can be made to the articles described herein. For example, the diffuser may comprise multiple distinct layers rather than only one layer. The indicia layer may likewise comprise multiple distinct layers. Alternatively, the diffuser and the indicia layer may be combined into only a single layer. If the diffuser and the indicia layers are distinct, they may be arranged in any order relative to the Fresnel mirrors. An asymmetric diffuser can be cut into an embossing or casting tool by creating a low amplitude, high frequency undulation of the prism height along the length axis of each prism or portions of the prisms.

In a given embodiment, Fresnel mirrors of a given type may be uniformly the same, or they may be different from each other, or they may be some combination thereof. For example, the Fresnel mirrors 417 in FIG. 4, or the Fresnel mirrors 517 in FIG. 5, may all have the same effective curvature and/or the same width w (see FIG. 2a), or the Fresnel mirror curvatures and/or widths may differ according to a regular or irregular pattern. Numerous combinations of focusing and/or defocusing Fresnel mirrors are contemplated, including embodiments with only focusing Fresnel mirrors, embodiments with only defocusing Fresnel mirrors, embodiments with focusing Fresnel mirrors interspersed with defocusing Fresnel mirrors, and all of the foregoing embodiments with the Fresnel mirrors arranged in a contiguous fashion as well as all of the foregoing embodiments with the Fresnel mirrors arranged in a non-contiguous fashion, with separation regions between the mirrors. The Fresnel mirrors need not be precisely linear in plan view. For example, the Fresnel mirrors (and the prisms or facets that make up the mirrors) may follow paths that are curved, and/or paths that extend generally along a particular in-plane direction but that oscillate (e.g. sinusoidally or in any other periodic or near-periodic fashion) or wander (e.g. characterized by deviations that are low in frequency, small in amplitude, and not periodic) with respect to that direction. Tooling used for embossing or casting/curing (e.g. an embossing drum or casting wheel) can be fabricated with non-linear patterns such as a wandering sand dune appearance or curly maple appearance. Although this can be accomplished with diamond tooling on a drum using multiple passes with a fast plunging tool, an alternative method is to use gray scale lithography wherein the prisms are created by the variable depth exposure of a photoresist with rastered laser beams.

The non-linear patterns can also be achieved by forming pliable prisms on an elastic substrate which can then be non-uniformly stretched in different areas across a surface. Such a construction was made by casting prisms with the resin described below in the First Wood-Like Example onto a pliable vinyl substrate that was 50 microns thick. Pliable Fresnel mirrors and lenses are also useful when applying the films to non-planar surfaces that are curved along both in-plane axes, i.e., compound curved surfaces. Some examples are lighting fixtures, luminaires, automobile exterior or interior surfaces, computer mouse surfaces, and mobile handheld electronic devices such as some phones, notepads, or notebook computers.

The Fresnel mirrors may have a plan view aspect ratio that is limited only by the outer physical boundaries or edges of the article, i.e., each of the Fresnel mirrors may extend from one such boundary or edge to an opposite boundary or edge. Alternatively, the Fresnel mirrors may each extend along a particular direction but have a length that is truncated relative to the physical boundaries of the article. Fresnel mirrors that are elongated along a particular direction may have a plan view aspect ratio of at least 2, 5, 10, 20, or 50, for example. In some cases, the Fresnel mirrors may have circular, square, or other non-elongated shapes in plan view.

When truncated Fresnel mirrors are used, it may be desirable for aesthetic purposes to arrange them such that small blank areas (e.g. small flat mirror areas or small flat window areas, characterized by the absence of any tilted or angled prism facets) separate adjacent Fresnel mirrors, which small blank areas may be spaced regularly or randomly along a given row of truncated Fresnel mirrors. The small blank areas can be achieved in at least two ways. In one case, the metal tool can be cut such that the cutting tool is retracted and does not cut a set of adjacent prisms for a predetermined length on the tool, or the prisms can be later machined flat on the metal tool at the predetermined lengths. Alternatively, if the prisms are cut continuously on a tool, the resulting cast polymer replicate of the tool can be planarized in local areas (corresponding to the small blank areas) by coating (planarizing) the prisms with a second film in those chosen areas. This discussion of Fresnel mirror films with truncated Fresnel mirrors can also be extended to Fresnel lens films made to have truncated Fresnel lenses. For Fresnel lenses, if a planarizing polymer coating is used, it should be transparent and relatively close to (in comparison to air or ULI material) the refractive index of the prisms, e.g. Δn<0.2. For Fresnel mirrors, the second coating need not be transparent if it is not on the viewer side of the metal coating. With either method of eliminating prisms in local areas, random or image forming patterns can be made via the absence of a prismatic structure on the film. Such spatial patterns can be considered indicia for the Fresnel films.

Exemplary embodiments of the disclosed articles comprise thin polymer-based films that are laminated, coextruded, and/or coated such that the article is self-supporting, flexible, and conformable to a target surface or object. In this regard, the disclosed articles may be configured such that the back surface of the article attaches to a wall or other object of interest, and light enters and exits the article through the front surface thereof. The disclosed articles may include additional layers and coatings to facilitate such applications, including e.g. planarization layer(s), adhesive layer(s), release liner(s), hard coat(s), and the like. The disclosed Fresnel mirror films can also be made with a transparent base film or substrate such that decorative reflective images or patterns can be viewed from both sides (opposite sides) of the film, keeping in mind that a given Fresnel mirror that is focusing when viewed from one side of the film is defocusing when viewed from the opposite side, and vice versa. Such films can be applied to windows or similar light-transmissive substrates, such as an interior office window, so that again decorative reflective images or patterns provided by the Fresnel mirrors can be viewed from both sides of the combination. In such applications, different indicia or color films can be applied to opposing sides of the film such that the window has a distinctly different appearance from each side. Colored and/or neutral gray dyes, pigments, and the like can be incorporated into one or more of the constituent layers (such as an indicia layer) of, or can be included as an additional colored or tinted layer in, any of the disclosed film or film stack embodiments, for further visual effect. Reflective color films such as multilayer interference films can provide striking visual effects when combined with the Fresnel lens and mirror films. Narrow band color mirror films, examples of which can be found in U.S. Pat. No. 6,531,230 (Weber et al.), “Color Shifting Film”, have been found to be particularly attractive in this construction. Narrow band mirrors have a transmission that is high (e.g. greater than 50%) when averaged over the visible spectrum, but a low transmission and high reflectivity (e.g. at least 30, 50, 60, 70, 80, 90, or 95% reflectivity) over a narrow spectral band in the visible, where the narrow spectral band may have a full width at half maximum (FWHM) of less than 150, or less than 100, or less than 70, or less than 50 nm, or in a range from any of these values to 10 nm. When laminated to or otherwise combined with the Fresnel films disclosed herein, such narrow band mirrors can produce a colored flash, e.g. of blue, green, or red, at given observation angle. In addition, the appearance is different when viewed from opposite sides of the laminate due to the differing angles of incidence and transmission of light for the mirror film depending on which side of the Fresnel mirror film the narrow band mirror is disposed on. The disclosed articles may be made of any suitable materials now known or later developed, including materials other than polymer-based films. The articles may include one or more thick and/or rigid and/or brittle component such that the resulting article is rigid rather than flexible.

### WOOD-LIKE EXAMPLES

Some articles having a wood-like appearance were made and evaluated. Each of these articles incorporated a Fresnel mirror film.

### First Wood-Like Example

A Fresnel lens film was first made by a casting and curing process. The Fresnel lens film was made by casting a faceted prism layer onto a flat film substrate using a copper tool in the form of a drum. The copper tool had been made previously by cutting grooves of specified depths and groove angles into the rotating copper drum using a diamond lathe. The pattern formed by the grooves was replicated to form the prism layer on the Fresnel lens film. This was done using a UV cast and cure resin of refractive index n≈1.5, and a flat 2 mil (50 micron) thick PET substrate. The resin was made with the following commercially available materials: 75% Photomer 6210 (Urethane Diacrylate from Cognis Corp, Cincinnati, Ohio); 25% SR238 1, 6 Hexanediol Diacryate from Sartomer USA, Exton, Pa.; and +1% Darocur 1173 Photoinitiator from BASF Chemical, Ludwigshafen, Germany.

This process produced a Fresnel lens film having formed thereon contiguous Fresnel lenses having a plan view similar to FIG. 2a, each Fresnel lens being defined by a series of small linear prisms whose individual prism slopes changed along the cross-web direction, from a maximum of +14.3 degrees on one edge of the lens to a minimum of −14.3 degrees on the opposite edge of the lens, with slopes at or near 0 degrees in a central region of each lens. Each Fresnel lens had a width, in the cross-web direction, of 12.7 mm, and an indefinite length, limited only by the length of the film, in the down-web direction. The width of the prisms varied across the width of each Fresnel lens. In the central region of each lens, where the prism slope was smallest in magnitude, the prisms had widths near 100 microns. The prisms at the edge of each lens, where the prism slope was greatest in magnitude (±14.3 degrees), had widths of about 75 microns. The height of the prisms also varied across the width of each Fresnel lens, the tallest prisms being at the edge of the lens and having a prism height of about 19 microns.

The Fresnel lens film formed by this process had a faceted outer surface, the facets defining a family of straight, parallel Fresnel lenses. The Fresnel lens film was substantially the same, with the same facet geometry, as a transmissive Fresnel lens product sold years ago by 3M Company, in the United States, as Accentrim™ Half Round Wide Web BW500. To convert the Fresnel lenses to Fresnel mirrors, a 12 cm×12 cm piece of the film was then metalized on the faceted surface with a vapor coating of aluminum. The reflectivity of the aluminum-coated film piece was at least 80%. The resulting Fresnel mirror film had a 2-layer construction in which the flat PET substrate film was covered by the faceted prism layer, the prism facets also being coated with the reflective metal. The reflective facets produced a series of contiguous linear Fresnel mirrors, which were all focusing-type mirrors when the product was viewed through the (transparent) PET substrate, and defocusing-type mirrors when the product was viewed from the opposite (metal-coated) side. For the 12 cm×12 cm piece of film, the Fresnel mirrors each had aspect ratios of about 10:1. For long rolls of the film, the aspect ratio can be as large as desired, e.g., greater than 100,000. The Fresnel mirrors were straight and linear in plan view. The Fresnel mirror film had a thickness of about 70 microns in the regions at the edges of the Fresnel mirrors, where the prism height was greatest.

A diffuser film was then made by extruding a polymer blend of resins which had dissimilar indices of refraction. In particular, a polycarbonate resin was used as a major phase and a polypropylene resin was used as a minor phase. This film was made using a melt coextrusion process. A three layer feedblock of ABA configuration was used. The skin layer A was extruded using a single screw extruder. A polypropylene (PP1024) was fed into this extruder using a hopper at a rate of about 4.5 kg per hour. The core layer B was extruded using a twin screw extruder. Two resins, a polypropylene resin (PP1024) and a polycarbonate resin (Makrolon 2207) were fed into this extruder at rates of 6.5 kg per hour and 4.4 kg per hour, respectively. The melt temperature for the single-screw extruder was controlled at about 266° C. and for the twin screw extruder was controlled at about 271° C. A film extrusion die was used to cast the melt on a casting wheel. The film was oriented on the casting wheel and the cast wheel speed was adjusted to make a 170 micron thick finished film. The diffuser film was asymmetric as a result of the fiber-like internal structure of the minor phase material. This was confirmed by shining a collimated visible laser beam through the diffuser film. The diffuser film converted the collimated beam into a scattered beam that fanned out substantially only along one in-plane axis, referred to here as the “scattering axis”. The scattering axis was substantially orthogonal to the axis along which the internal fiber-like structures were aligned. The ratio of β1/α1 and β2/α2 (discussed above in connection with FIG. 7) was estimated to be greater than about 25. The total transmission of the diffuser film, averaged over the visible spectrum, was measured to be about 82%. The overall haze of the diffuser film was measured using a Haze-Gard Plus haze meter, available from BYK-Gardner, Columbia, Md., the measured haze being 95%. A 12 cm×12 cm piece of this diffuser film was then laminated to the Fresnel mirror film piece using an optically clear adhesive, such that the optically clear adhesive was sandwiched between the metal-coated structured surface (which was planarized by the adhesive) and the diffuser film. The diffuser film was oriented relative to the Fresnel mirror film such that the scattering axis of the diffuser film was substantially parallel, e.g., within about 5 degrees, to the direction of elongation of the Fresnel mirrors.

An indicia film was made by printing indicia on a standard transparency film (125 micron thick polyester). The indicia was a photograph image of a wood surface, the image including wood grain features. The indicia was printed on the transparency film using a conventional ink-jet printer. A 12 cm×12 cm piece of the indicia film was then laminated to the 12 cm×12 cm diffuser film/Fresnel mirror film combination piece using an optically clear adhesive such that the diffuser film was sandwiched between the indicia film and the Fresnel mirror film. The indicia film was oriented such that the wood grain features were elongated in a direction approximately perpendicular to the direction of elongation of the Fresnel mirrors.

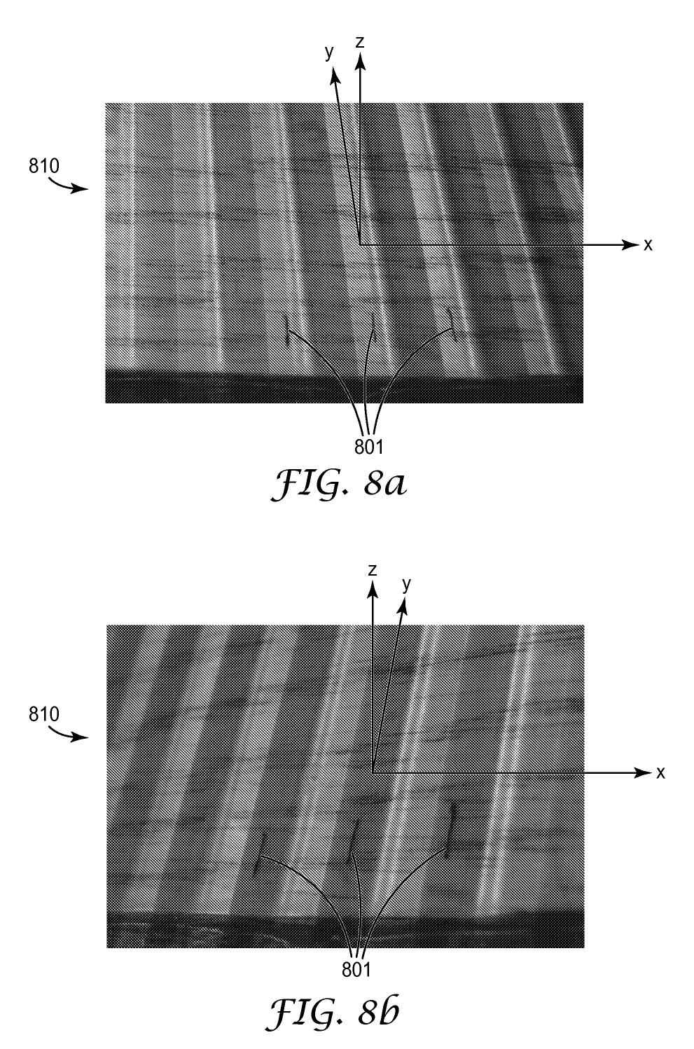

The resulting 12 cm×12 cm film article was flexible and had an overall thickness of about 400 microns. (If desired, the overall thickness can be greatly reduced by combining more than one function in single layer, thereby eliminating extra substrates and adhesive layers. Overall thickness values of 200 microns or even 100 microns are readily achievable.) The film article had a 3-dimensional wood-like appearance. It was placed on a flat surface in an office environment and photographed with a camera from two different camera positions/orientations. The resulting photographs are provided in FIGS. 8a and 8b, where the film article is labeled 810. Superimposed on each of the photographs is a Cartesian x, y, z coordinate system. A pen was used to place three fixed reference marks 801 on the front surface of the article. The superimposed coordinates are oriented such that the y-axis is generally parallel to the elongation direction of the Fresnel mirrors and to the elongation direction of each of the reference marks 801. The x-axis is approximately aligned with the wood grain features of the indicia film.

As shown in FIGS. 8a and 8b, the Fresnel mirror film provides the article 810 with a pattern of relatively wide bright and dark stripes or bands that alternate with each other. These stripes mimic the effects of the figure of a piece of wood. Thus, although the illumination geometry was identical for the photographs of FIGS. 8a and 8b, the shifting position and orientation of the camera (observer) causes the stripes to shift in position along the x-axis: in FIG. 8a, each of the reference marks 801 coincides with a bright stripe, whereas in FIG. 8b the same reference marks 801 coincide with dark stripes. In addition to this shifting behavior, when the article 810 was observed from a given stationary position with both eyes, the reflection of the ambient light by the Fresnel mirror film gave the article an appearance of “depth”, i.e., a 3-dimensional character.

### Second Wood-Like Example

Another wood-like film article was made. This second wood-like film article was substantially the same as the first wood-like film article, except the Fresnel mirror film was made using a vapor coating of nickel rather than aluminum. This resulted in the Fresnel mirror film having a visible light reflectivity of about 50% rather than 80%. The finished wood-like film article was noticeably darker in appearance than the first wood-like film article, but otherwise exhibited the same visual characteristics reported above for the first wood-like example.

### Third Wood-Like Example

Another wood-like film article was made with substantially identical components and construction as article 810 of the first wood-like example. The only significant difference between the article of this third wood-like example and article 810 of the first wood-like example is that the diffuser film was rotated 90 degrees such that the scattering axis was perpendicular, rather than parallel, to the direction of elongation of the Fresnel mirrors.

In this example, the 3-dimensional appearance of the article, and the directional nature of the Fresnel mirror reflectivity, was almost completely absent. No bright or dark bands corresponding to the Fresnel mirrors were observed at any observation geometry.

### Fourth Wood-Like Example

Another wood-like film article was made with substantially identical components and construction as article 810 of the first wood-like example, except that the asymmetric diffuser film was replaced with a symmetric diffuser film. The symmetric diffuser film was made using a melt coextrusion process. A three layer feedblock of ABA configuration was used. The skin layer A was extruded using a single screw extruder. A polyester resin, PET, was fed into this extruder using a hopper at a rate of about 4.5 kg per hour. The core layer B was extruded using a twin screw extruder. Two resins, a copolyester of PEN (55 mol % of NDA and 45 mol %TA) and a polyolefin resin (Exact 8201) were fed into this extruder at rates of 3.6 kg per hour and 0.91 kg per hour, respectively. The melt temperature for the single-screw extruder was controlled at about 277° C. and for the twin screw extruder was controlled at about 271° C. A film extrusion die of about 15 cm width was used to cast the melt on a casting wheel. The resulting cast web was then stretched to a 3.5×3.5 draw ratio at about 95° C. and 50%/sec rate. The stretched film had a final thickness of about 2.7 mil (about 70 microns). The haze of the symmetric diffuser film was measured using a Haze-Gard Plus haze meter, available from BYK-Gardner, Columbia, Md., the measured haze being 81%. The total transmission of the diffuser film, averaged over the visible spectrum, was measured to be about 80%. Similar to the procedure used for article 810, the symmetric diffuser was laminated between the Fresnel mirror film and the indicia layer using optically clear adhesive, thus producing the third wood-like film article.

The resulting article was viewed under ordinary office lighting. When viewed from a stationary position with both eyes, the appearance of “depth” was greatly reduced relative to article 810. However, the article of this fourth wood-like example did clearly exhibit the apparent dark and bright bands associated with the Fresnel mirrors, and, like the bands observed with article 810, these bands also shifted in appearance with shifting viewing angle/geometry. Hence, this article also exhibited a 3-dimensional wood-like appearance.

### Fifth Wood-Like Example

An additional wood-like film article was made. This fifth wood-like film article used an aluminum-coated Fresnel mirror film that was similar in construction to that used in the first wood-like example, i.e., the Fresnel mirror film again had a UV-cured prism layer cast on a flat 2 mil (50 micron) thick PET substrate, and the prism facets were coated with aluminum, but in this case the prism facet pattern (and thus the Fresnel mirror design) was different. A different tool, with different groove angles, was used to form the faceted surface of the prism layer.

In this case, the individual prism slopes changed along the cross-web direction in a sinusoidal fashion, which resulted in the Fresnel mirror film having contiguous linear Fresnel mirrors that alternated between focusing-type mirrors and defocusing-type mirrors (regardless of which side the Fresnel mirror film was viewed from), similar to the interface 215 in FIGS. 2 and 2a. The sinusoidal slope sequence had a periodicity of 40 mm. Each Fresnel mirror was defined by a series of small linear prisms whose individual prism slopes changed along the cross-web direction, from a maximum of +14.3 degrees on one edge of the mirror to a minimum of −14.3 degrees on the opposite edge of the mirror, with slopes at or near 0 degrees in a central region of each mirror. Each Fresnel mirror had a width, in the cross-web direction, of 20 mm (half the period of the sinusoid), and an indefinite length, limited only by the length of the film, in the down-web direction. The width of the prisms was constant at 75 microns across the width of each Fresnel mirror. The Fresnel mirror film had a thickness of about 70 microns in the regions at the edges of the Fresnel mirrors, where the prism height was greatest. This film was laminated to a 3 mm thick glass plate with an adhesive such that the adhesive was sandwiched between the metal-coated prisms (the layer of adhesive planarized the structured surface) and the glass plate.

An indicia film was then made and laminated to this Fresnel mirror film/glass plate combination using an optically clear adhesive, such that the indicia film contacted the PET substrate of the Fresnel mirror film, and the embossed surface of the indicia film was exposed to air on the front outside surface of the laminate. Note that for this fifth wood-like example, no separate diffuser film was included in the construction between the Fresnel mirror film and the indicia film. The indicia film was an 80 micron thick vinyl film on which was printed simulated wood grain indicia, the vinyl film also being embossed on one side with small elongated depressions similar to wood texture. This indicia film was substantially the same as an indicia film used as a component in simulated wood grain film products sold more than one year ago in the United States by 3M Company as 3M™ DI-NOC™ Film. This indicia film provided some diffusion of light: when a collimated laser beam was directed at the indicia film, the scattered transmitted beam was elongated along an in-plane scattering axis. The scattered beam had a ratio of η1/α1 and β2/α2 (discussed above in connection with FIG. 7) estimated to be about 1.5. The scattering axis of the indicia film was perpendicular to the direction of the wood grain in the wood grain indicia. When laminated to the sinusoidal Fresnel mirror film, the indicia film was oriented such that the scattering axis was substantially parallel, e.g., within about 5 degrees, to the direction of elongation of the Fresnel mirrors.

The resulting laminated article, referred to here as the fifth wood-like film article, was stiff and had an overall thickness of greater than 3 millimeters, due to the presence of the glass plate. The film article had a 3-dimensional wood-like appearance. When viewed in a standard office environment, alternating bright and dark stripes or bands, with the same 20 millimeter periodicity as the Fresnel mirrors, were clearly visible as the result of the Fresnel mirror film, and these bands mimicked the effects of the figure of a piece of wood by appearing to shift in response to a shifting viewing geometry and/or illumination geometry. The bands did not have an unduly harsh appearance as a result of a sufficiently low visible light transmission and adequate amount of light diffusion provided by the indicia layer. In addition to the shifting behavior, when the article was observed from a given stationary position with both eyes, the reflection of the ambient light by the Fresnel mirror film gave the article an appearance of “depth”, i.e., a 3-dimensional character.

### Further Discussion

We have found that the Fresnel mirror films discussed herein can be used not only to make articles having a 3-dimensional wood-like appearance, but can also be used to make other decorative films and articles with unique and interesting visual appearances. Of particular note are linear Fresnel mirror films in combination with linear Fresnel lens films and/or in combination with diffusers, including asymmetric diffusers, and/or in combination with indicia, and/or in combination with diffractive films or elements. These films and/or combinations can also include additional layers and coatings as discussed herein.

With regard to Fresnel mirror films in combination with diffusers, reference is made to the discussion elsewhere here relating to the benefits associated with combining an asymmetric diffuser with a Fresnel mirror film whose individual mirrors are, in plan view, linear or otherwise elongated along a particular in-plane axis. By substantially aligning the axis of maximum diffusion with the elongation axis of the mirrors, e.g., where the angle between these axes is less than 60, 45, 30, 20, 10, or 5 degrees, for example, the diffuser can soften an otherwise harsh appearance of the mirrors with minimal or at least reduced interference with the focusing and/or defocusing characteristics of the mirrors. Thus, for example, articles similar to those of FIGS. 2, 4, and 5 may be fabricated, but the indicia layer may be modified to comprise indicia other than wood-like indicia, e.g., one or more decorative patterns of any style. Alternatively, the indicia layer may instead be simply omitted from the construction.

Since the Fresnel structures described herein can be used for decorative applications, indicia can play an important and synergistic role in enhancing the films, film stacks, and film articles for aesthetic purposes. The Fresnel structures provide a basis for interesting and decorative optical effects, and indicia can be added to complement the periodic structure of the Fresnel lens arrays, or alternatively the indicia can be applied to break up the repetitiveness of a periodic lens array. Indicia also provide a convenient means with which to customize a given array of Fresnel lenses or mirrors. Indicia layers may be made with a gray scale of black and white inks, and they may also or alternatively be made with colored inks, such as blue, green, yellow, and/or red, and so forth. As described elsewhere herein, indicia can be formed using a variety of different techniques, and can be incorporated into or onto one or more constituent layers or surfaces of the articles.

Referring to content and style, the term indicia can include a wide range of types of patterns that can be applied to the decorative films described herein. With simulated wood grain films, for example, the indicia may be photographic images or artistic renderings of wood grain or the like. In other cases, the indicia can be or comprise images of other objects. In order to either complement or break up the periodic appearance of the Fresnel prism arrays, the indicia can alternatively be, for example, known geometric shapes such as lines, rectangles, squares, circles, etc. formed by a non-continuous areal application of printed inks or pigments, diffusers, or the elimination or absence of Fresnel prisms, that are applied in registration with the lens or mirror arrays. The registration can be in terms of distance along the x-axis and the indicia can also be discontinuous along the y-axis. In such cases, the indicia may be tailored to cover less than 10% or less than 25% or less than 50% of the total area of the film in plan view.

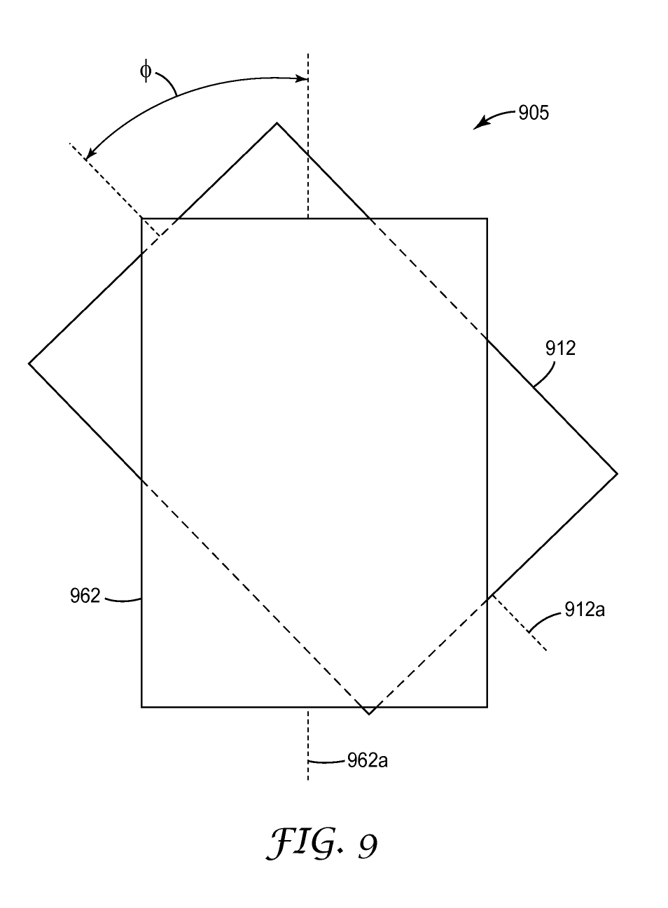

With regard to linear Fresnel mirror films in combination with linear Fresnel lens films, the reader's attention is directed to FIGS. 9 through 14.

Before discussing these figures, however, we provide a short discussion of Fresnel lens films. In short, any and all of the Fresnel mirror films described elsewhere herein can be modified to form Fresnel lens films by making the individual facets (see e.g. facets 216, 416, 516, 616) of the faceted interfaces (see e.g. interfaces 215, 415, 515, 616) transmissive rather than reflective, and, by not positioning a flat reflector in close proximity to the facets as was shown in FIG. 6b. With such modifications, the Fresnel mirror films discussed elsewhere, including but not limited to Fresnel mirror films 212, 412, 512, 612, and 652, can be made to be Fresnel lens films. Like the Fresnel mirror films, it is generally desirable, although not necessary in all cases, for the Fresnel lens films to have a “buried” structure. That is, it is desirable for the faceted surface of the Fresnel lens film to be planarized on both sides with tangible material layers, rather than having the faceted surface exposed to air or vacuum. This is so that the Fresnel film can be readily incorporated into a laminated construction (in which the facets are physically protected) without destroying the operation of the Fresnel lenses, and/or so that the facets of the Fresnel film can be protected from abrasion, dirt, or other exterior physical influences. The tangible material layers should, in addition to being transparent to visible light, have different refractive indices so that refraction of light can occur at the facets.

Analogous to the Fresnel mirror films, the Fresnel lens films can include any suitable arrangement of focusing lenses and/or defocusing lenses, whether contiguous or non-contiguous. With respect to focusing Fresnel lenses and defocusing Fresnel lenses, the reader is cautioned that, when the facets of a focusing Fresnel mirror film are rendered non-reflective, the result may be a defocusing Fresnel lens rather than a focusing Fresnel lens. Similarly, when the facets of a defocusing Fresnel mirror film are rendered non-reflective, the result may be a focusing Fresnel lens rather than a defocusing Fresnel lens. Stated differently, for a given faceted structure, such as the faceted structure labeled 217a or the faceted structure labeled 217b in FIG. 2, one cannot determine whether a Fresnel lens having that faceted structure is a focusing lens or a defocusing lens, unless the refractive indices of the media on opposite sides of the structured surface are known. Thus, with regard to the faceted structure 217a, which was referred to above as a focusing Fresnel mirror, that structure produces (when the facets are rendered non-reflective) a focusing Fresnel lens if the first layer 213 has a greater refractive index than the second layer 214, but produces a defocusing Fresnel lens if the first layer 213 has a smaller refractive index than the second layer 214. Similarly, with regard to the faceted structure 217b, which was referred to above as a defocusing Fresnel mirror, that structure produces (when the facets are rendered non-reflective) a defocusing Fresnel lens if the first layer 213 has a greater refractive index than the second layer 214, but produces a focusing Fresnel lens if the first layer 213 has a smaller refractive index than the second layer 214.

For a faceted interface having a sinusoidal or sinusoidal-like slope sequence such as the faceted interface 215 of FIG. 2, such an interface will produce an alternating sequence of focusing and defocusing Fresnel lenses provided the first and second layers 213, 214 have different refractive indices. In one case, where the refractive index of the first layer 213 is greater than that of the second layer 214, the faceted structure labeled 217a will be (when the facets are rendered non-reflective) a focusing Fresnel lens and the structure labeled 217b will be a defocusing Fresnel lens. In the other case, where the refractive index of the first layer 213 is less than that of the second layer 214, the faceted structure labeled 217a will be (when the facets are rendered non-reflective) a defocusing Fresnel lens and the structure labeled 217b will be a focusing Fresnel lens.

In general, the strength or optical power of a Fresnel lens, whether focusing or defocusing, is increased for a given facet geometry if the refractive index difference between the layers in increased, and decreased if the refractive index difference between the layers is decreased. It may be desirable in some cases to design the Fresnel lens film to have a relatively weak optical power, by selecting materials for the first and second layers that have refractive indices close in value. In other cases, it is desirable to design the Fresnel lens film to have a stronger optical power by selecting materials with widely separated refractive indices. From a design standpoint, increasing the refractive index difference also allows a Fresnel lens (or mirror) of a specified focal length or optical power to employ facets with decreased orientations or slopes. Examples of polymer materials that may be used in the light transmissive first and/or second layers include, but are not limited to: high index resins such as those used in prismatic brightness enhancement films made for use in liquid crystal displays, such resins having refractive indices in a range from about n≈1.55 to n≈1.70; ultra low index (ULI) nanovoided materials discussed in patent application publications WO 2010/120864 (Hao et al.) and WO 2011/088161 (Wolk et al.), having refractive indices in a range from about n≈1.15 to n≈1.35; PMMA (n≈1.49); polycarbonate (n≈1.59); silicones (n≈1.4), including silicone adhesives; and fluorocarbon materials (n≈1.35).

With this background we turn to FIG. 9. There, a schematic front or plan view of a film stack 905 depicts a Fresnel mirror film 912 disposed below or behind another film component such as a Fresnel lens film 962. The mirror film 912 is shown as having a reference axis 912a, and the lens film 962 is shown as having a reference axis 962a. For the present discussion, we assume the mirror film 912 comprises an arrangement of focusing and/or defocusing Fresnel mirrors that are each elongated generally parallel to the axis 912a. We similarly assume the lens film 962 comprises an arrangement of focusing and/or defocusing Fresnel lenses that are each elongated generally parallel to the axis 912a. The films are rotated relative to each other, i.e., their axes 912a, 962a are non-parallel. A nonzero angle (Greek letter phi) is formed between the axes 912a, 962a. We have found that unique aesthetically pleasing visual effects can result from such combinations of films. The angle may be in a range from 5 to 90 degrees, for example.

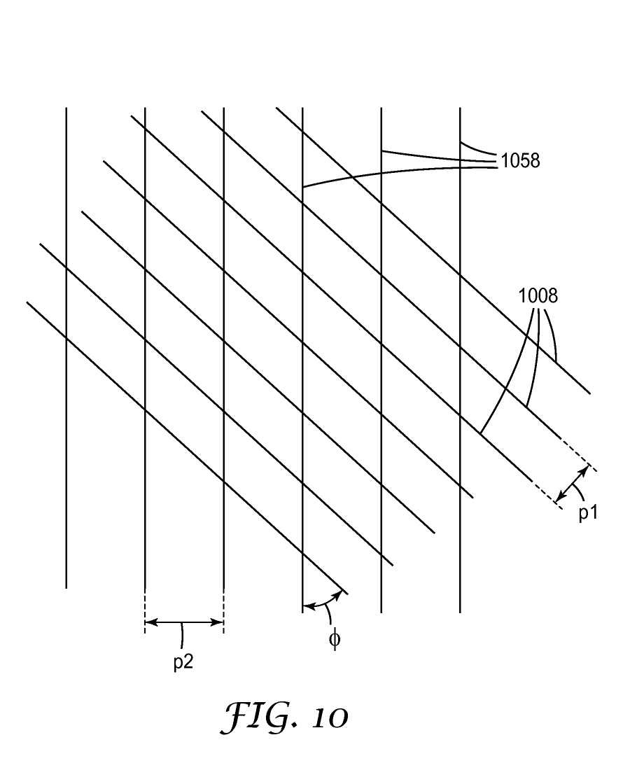

Another factor that affects the appearance of such a film stack is the relative spacing or pitch of the Fresnel mirrors and the Fresnel lenses. FIG. 10 is a front or plan view of schematic representations of Fresnel mirrors and Fresnel lenses as they may be arranged in a film stack such as that of FIG. 9. Here, lines 1008 represent the centers of adjacent Fresnel mirrors, e.g. Fresnel mirrors in the mirror film 912, and lines 1058 represent the centers of adjacent Fresnel lenses, e.g. Fresnel lenses in the lens film 962. The films are oriented such that the mirrors and lenses are tilted at an angle relative to each other.

For simplicity, we assume the Fresnel mirrors have a uniform center-to-center spacing or pitch pl. We also assume for simplicity that the Fresnel lenses have a uniform center-to-center spacing or pitch p2. Fresnel films with uniform spacing are convenient to work with because they can be cut or otherwise converted into any desired size or shape without concern for where the cut should be made on the film. (Fresnel lens films and/or Fresnel mirror films with nonuniform spacing can, however, also be used.) The values of p1 and p2 may be selected as desired to produce a pleasing visual effect. In some cases p1 may be equal to p2, within manufacturing tolerances. For example, the magnitude of (p2−p1)/p1 may be less than 1%. We have found that particularly interesting visual effects are produced when p1 and p2 are moderately different from each other, e.g., p1/p2 or its reciprocal may be in a range from 1.5 to 3.

Whether or not the Fresnel mirrors and/or Fresnel lenses have uniform center-to-center spacings, the pitches p1, p2 may alternatively refer to average values. Thus, p1 may be the average pitch of the Fresnel mirrors in the Fresnel mirror film, and p2 may be the average pitch of the Fresnel lenses in the Fresnel lens film, and p1 and p2 may be the same or different as set forth above. The Fresnel mirrors and lenses may also be characterized in terms of their plan-view widths. See e.g. “w” in FIG. 2a and “w1” in FIG. 5a. The Fresnel mirrors may be characterized by an average Fresnel mirror width, and the Fresnel lenses may be characterized by an average Fresnel lens width different from the average Fresnel mirror width.

If desired, the Fresnel films of the film stack may be specifically adapted to adhere to each other in a laminate. In some cases, the Fresnel mirror film and the Fresnel lens film may be sold separately, and applied to each other at any desired orientation (rotation angle) by a contractor, customer, or other end-user.

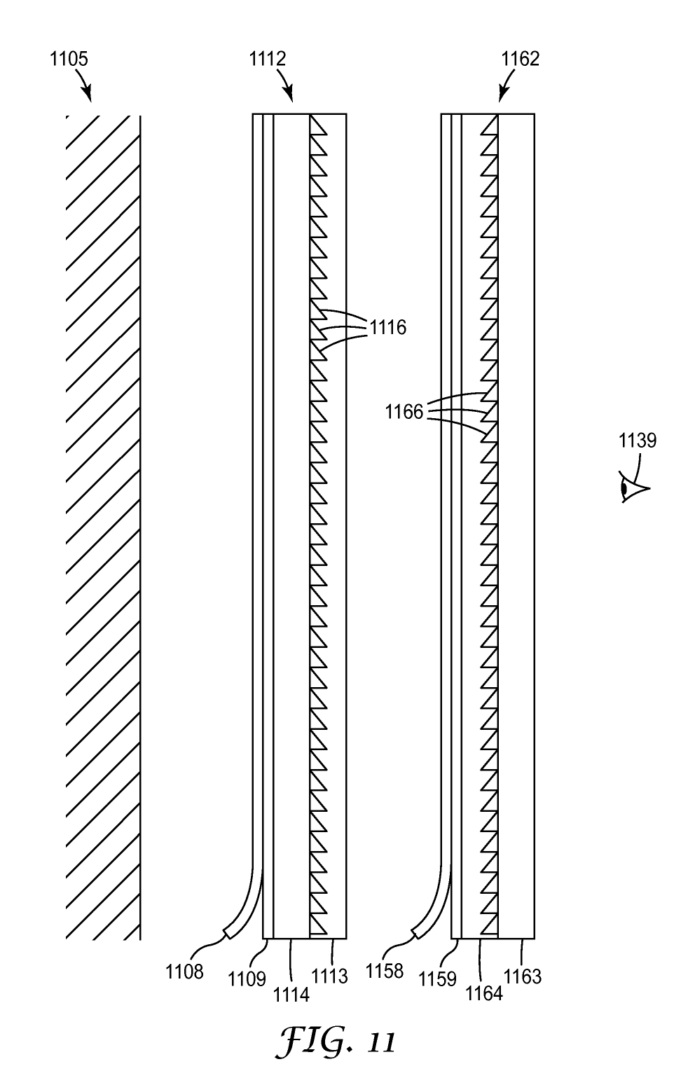

For example, in FIG. 11, two films 1112, 1162 may be manufactured and sold separately to a customer. The film 1112 is a Fresnel mirror film, and film 1162 is a Fresnel lens film. The film 1112 includes a first layer 1113, a second layer 1114, an adhesive layer 1109, and a release liner 1108 which allows the film 1112 to be handled before being adhered to a workpiece 1105 such as a wall or partition. A thin layer of prisms (not labeled in FIG. 11) with reflective facets 1116 and substantially no land portion is shown as being cast and cured on the second layer 1114, with the first layer 1113 acting as a planarization layer; in alternative embodiments a thin prism layer may be cast and cured on a flat film version of the layer 1113, and the layer 1114 may then act as a planarization layer; in still other embodiments the surface of the layer 1114 (or the surface of layer 1113) may itself be embossed such that the thin prism layer in essence becomes part of the layer 1114 (or part of layer 1113), with the layer 1113 (or the layer 1114) then acting as a planarization layer. Planarization layers may be made of a transparent adhesive or other suitable transparent polymer (e.g. a ULI material discussed below). For the remainder of this discussion, for simplicity, we will ignore the boundary between the thin prism layer and the layer 1114 and assume the thin prism layer is part of the layer 1114, such that the interface between layers 1114 and 1113 is the structured or faceted surface with facets 1116. In some cases, such as when film 1112 is to be applied alone on a window for example, it may be desirable to have a layer of polyethylene terephthalate (PET) or other suitable polymer applied to an adhesive planarization layer 1113, as well as the other adhesive layer 1109. In such a construction, tough polymer film layers are provided on both sides of the Fresnel prisms, and removal of the entire film construction from a wall or window may be facilitated, depending on the interfacial adhesion of the other layers. Alternatively, adhesive and liner layers 1108 and 1109 can be applied to the planar surface of a non-adhesive layer 1113. The facets 1116 are shown only schematically in FIG. 11, but the reader will understand that they are arranged in a sequence of orientations or slopes that define a plurality of contiguous or non-contiguous focusing and/or defocusing Fresnel mirrors as described elsewhere herein. The Fresnel mirrors may be linear or otherwise extended along a particular in-plane direction as shown in FIG. 10.

Similar to film 1112, the film 1162 includes a first layer 1163, a second layer 1164, and a faceted surface with transmissive facets 1166 formed between the first and second layers. Also similar to film 1112, a thin layer of prisms (not labeled in FIG. 1) with transmissive facets 1166 and substantially no land portion is shown as being cast and cured on the first layer 1163, with the second layer 1164 acting as a planarization layer; in alternative embodiments a thin prism layer may be cast and cured on a flat film version of the layer 1164, and the layer 1163 may then act as a planarization layer; in still other embodiments the surface of the layer 1163 (or the surface of layer 1164) may itself be embossed such that the thin prism layer in essence becomes part of the layer 1163 (or part of layer 1164), with the layer 1164 (or the layer 1163) then acting as a planarization layer. Planarization layers may be made of a transparent adhesive or other suitable transparent polymer (e.g. a ULI material discussed below), but for Fresnel lens films the planarization layer preferably has a significantly lower refractive index than the layer it planarizes, e.g., with a refractive index difference of more than about 0.1. For the remainder of this discussion, for simplicity, we will ignore the boundary between the thin prism layer and the layer 1163 and assume the thin prism layer is part of the layer 1163, such that the interface between layers 1163 and 1164 is the structured or faceted surface with facets 1166. The layers 1163, 1164 are both transparent or otherwise light transmissive, and have different refractive indices. The facets 1166 are shown only schematically in FIG. 11, but the reader will understand that they are arranged in a sequence of orientations or slopes that define a plurality of contiguous or non-contiguous focusing and/or defocusing Fresnel lenses as described elsewhere herein. The Fresnel lenses may be linear or otherwise extended along a particular in-plane direction as shown in FIG. 10. The film 1162 also includes a transparent adhesive layer 1159, and a release liner 1158 to allow the film 1162 to be handled before being adhered to the front surface of the mirror film 1112. The adhesive and liner layers may alternatively be applied to the planar surface of layer 1163, and a second adhesive layer with liner may optionally be applied to layer 1164 to facilitate lamination to a mirrored Fresnel film or transparent substrate such as a window. If the adhesive has a large enough refractive index difference relative to the prisms, the adhesive layer can be layer 1164. The surface that is exposed to the environment can be enhanced with one or more of the following functional coatings: anti-reflection, anti-glare, hard coat, or fluorocarbon “easy clean” coating.

In practice, the customer or other user may initially remove the release liner 1108 and apply the Fresnel mirror film 1112 to the workpiece in a particular orientation. Next, the user may wish to evaluate a range of different relative rotation angles of the two films (refer to angle in FIGS. 9 and 10) to determine its effect on the appearance of the combination. In this regard, it is beneficial to make the release liner 1158 out of a transparent material such as PET, so that the user can place the lens film 1162 against the mirror film 1112 and still have the ability to slide, rotate, or shift the lens film 1162 relative to the mirror film, while observing the appearance of the film combination resulting from light that is both transmitted through lens film 1162 and reflected by mirror film 1112, in order to ascertain the optimal orientation. Refer in this regard to user 1139 positioned in front of the films. After the desired orientation is selected, the release liner 1158 may be removed and the lens film 1162 applied to the mirror film 1112 to provide a finished, laminated film stack.

Film stacks that include a linear Fresnel mirror film and a linear Fresnel lens film may also desirably include a diffuser that is disposed to scatter light reflected by the Fresnel mirrors. The diffuser may be symmetric or asymmetric, and may have an overall haze in a range from 0 to 90% if it is symmetric, and from 0 to 99% if it is asymmetric. If the diffuser is asymmetric, it is preferably oriented such that the axis of maximum diffusion is perpendicular to neither the elongation axis of the Fresnel mirrors nor the elongation axis of the Fresnel lenses. The diffuser may be a distinct diffuser layer, or it may be incorporated into the Fresnel mirror film and/or the Fresnel lens film. The diffuser may be spatially uniform and coextensive with other films or layers, or it may be patterned (spatially non-uniform) to provide a regular, irregular, or random pattern of high and low (including zero) haze for additional visual effects. Such spatially patterned diffusers can be applied to one or more suitable surfaces of the optical films, and can be considered indicia for the films.

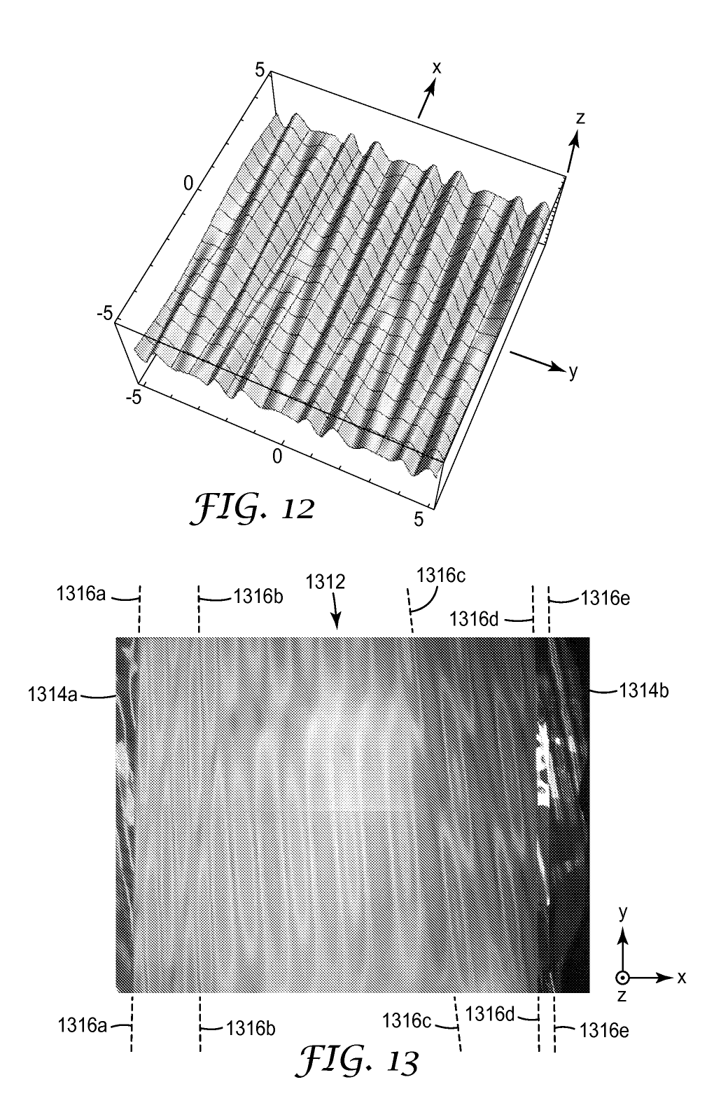

The appearance of film stacks having a linear Fresnel mirror film and a linear Fresnel lens film can be modeled or simulated. The result of one such simulation is provided in FIG. 12. For purposes of that figure, we assumed the Fresnel mirrors were all strictly linear, parallel, and contiguous, e.g. having a plan view similar to that shown in FIG. 2a. We likewise assumed the Fresnel lenses were linear, parallel and contiguous. Linear Fresnel components are advantageous because, in the context of fabricating an embossing tool by diamond turning grooves in a cylindrical tool, it is far easier to fabricate such an embossing tool with straight grooves than with grooves that deviate in some fashion in the transverse direction.

For purposes of FIG. 12 we also assumed the Fresnel mirrors, as well as the Fresnel lenses, used sinusoidal slope sequences such as that depicted in FIG. 2. This provides alternating contiguous focusing and defocusing mirrors in the Fresnel mirror film, and alternating contiguous focusing and defocusing lenses in the Fresnel lens film.

For the simulation, the Fresnel mirror film was represented by a first sine wave of the form

sin(t+2πx),

where

t=3 sin(x²),

and x is the position along the (in-plane) x-axis, which we may assume is the cross-web direction for a polymer film. The Fresnel lens film was represented by a second sine wave, of the form

sin(2πx′).

Here, x′ is the position along an (in-plane) x′ axis, the x′ axis being rotated relative to the x-axis by an angle, hence:

x′=x cos(φ)+y sin(φ), and

y′=−x sin(φ)+y cos(φ).

The sum of the two functions can be used to simulate the combined appearance of the two functions, i.e., of a Fresnel mirror film and a Fresnel lens film rotated by an angle:

z=0.2 sin(t+2πx)+0.2 sin(2πx′).

where z in this equation is a measure of the apparent height of a three dimensional surface, but we may also interpret z as representing brightness for purposes of the simulation. If we select the angle to be about 6 degrees, the simulated brightness from the above equations is as shown in FIG. 12.

The reader is again cautioned that the z-axis in FIG. 12 represents brightness, not position, for purposes of this simulation. However, the x- and y-axes in FIG. 12 do represent position at the output surface of the film combination. Inspection of FIG. 12 reveals that an intensity pattern that varies in two orthogonal in-plane directions, i.e. the x- and y-directions, can be produced from the combination of two purely linear functions, if one of the linear functions is rotated relative to the other one. The intensity pattern has an aesthetically pleasing sand dune-like or gentle wave-like appearance.

### DECORATIVE EXAMPLES

Some articles having a decorative appearance, but not a wood-like appearance, were made and evaluated. Each of these articles incorporated a stack of a linear Fresnel mirror film and a linear Fresnel lens film.

### First Decorative Example

Optical films with linear Fresnel structures were made by a casting and UV curing process using a metal roll tool that had been diamond turned. Grooves in the metal tool defined two adjacent regions of different sinusoidal groove patterns: a short periodicity pattern and a long periodicity pattern. When this tool was used to cast and cure a prism layer on a film substrate, the grooves produced small linear prisms defining two adjacent regions of the prism layer, each region having parallel linear prisms whose individual prism slopes changed along the cross-web direction in a sinusoidal fashion. In each of the regions, the prisms had a constant pitch (center-to-center prism distance) of 75 microns, and slopes that changed with cross-web direction in a sinusoidal manner, one cycle of each sinusoidal pattern having slopes that ranged from a maximum of +14.3 degrees, then diminishing to substantially zero degrees, then diminishing further to a minimum of −14.3 degrees, then increasing to substantially zero degrees, and then increasing still further back to the maximum of +14.3 degrees. Any given sinusoidal cycle in either of these regions defined a set of one focusing Fresnel structure contiguous to one defocusing Fresnel structure, where “Fresnel structure” refers to a Fresnel lens before a reflective coating is provided on the prism faces, but refers to a Fresnel mirror after a reflective coating is provided on the prism faces. In the short periodicity region, the period of each one of the sinusoids was 20 mm, and in the long periodicity region the period of each one of the sinusoids was 40 mm. The cross-web width of the short periodicity region was about 23 cm, i.e., 11.5 pairs of the narrower focusing/defocusing linear Fresnel structures. The cross-web width of the long periodicity region was also about 23 cm, i.e., almost 6 pairs of the wider focusing/defocusing linear Fresnel structures. In addition to the focusing and defocusing Fresnel structures within each region being contiguous to each other, the two regions were also contiguous to each other, along a shared linear boundary. The Fresnel structures (lenses) in the short periodicity region had a first uniform focal length (magnitude), and those in the long periodicity region had a second uniform focal length (magnitude), the first focal length being about 16 mm and the second focal length being about 32 mm.

Several optical films were made having these Fresnel structures formed in a prism layer atop a PET base film, the prism layer being made of a UV-cured resin of refractive index n≈1.65. The resin was filled with nano-zirconia particles in order to achieve the high index of refraction. Such resin is described for example in U.S. Pat. No. 7,264,872 (Walker, Jr. et al.). One such optical film was converted to a Fresnel mirror film by metalizing the faceted surface with a vapor coating of aluminum. The reflectivity of the metalized facets was at least 80%. The Fresnel mirror film thus had a short periodicity region of the narrower focusing/defocusing Fresnel mirrors, and a long periodicity region of the wider focusing/defocusing Fresnel mirrors. Another one of the optical films was left uncoated, and was used as a Fresnel lens film. The Fresnel lens film thus also had a short periodicity region of the narrower focusing/defocusing Fresnel lenses, and a long periodicity region of the wider focusing/defocusing Fresnel lenses.

A film stack was made by laying the Fresnel lens film atop the Fresnel mirror film, and then laying a diffuser film atop the Fresnel lens film. The diffuser film was of the same design and construction as the diffuser film used in the first wood-like example. No optical adhesive was used to bond the Fresnel mirror film to the Fresnel lens film, and no optical adhesive was used to bond the Fresnel lens film to the diffuser film, although such adhesives can be used to provide a stable laminate structure and to eliminate the small air gaps between the films. The film stack was placed on a flat horizontal surface in an office environment, and a camera was used to obtain a front or top view photograph of the stack 1312, the photograph provided in FIG. 13. A Cartesian x-y-z coordinate system is also shown in the figure for reference purposes, along with a number of dashed reference lines 1316a through 1316e. The left and right borders of the photograph are identified by reference numbers 1314a and 1314b, respectively.

The various films used to produce the stack 1312 overlap with each other in most, but not all, of the photograph. The Fresnel mirror film, at the bottom of the stack 1312 (in relation to the z-axis), extends from reference line 1316a to 1316e, and the individual Fresnel mirrors are oriented along in-plane axes that are parallel to the y-axis. The short periodicity region of the Fresnel mirror film, in which the sinusoidal period is 20 mm, extends from reference line 1316a to 1316b. The long periodicity region of the Fresnel mirror film, in which the sinusoidal period is 40 mm, extends from reference line 1316b to 1316e.

The Fresnel lens film, in the middle of the stack 1312 (in relation to the z-axis), extends from the left edge 1314a of the photograph to essentially the right edge 1314b of the photograph, and the individual Fresnel lenses are oriented along in-plane axes that are parallel to the reference line 1316c, which forms an angle of about 10 degrees relative to the y-axis. The long periodicity region of the Fresnel lens film, in which the sinusoidal period is 40 mm, extends from edge 1314a to the reference line 1316c. The short periodicity region of the Fresnel lens film, in which the sinusoidal period is 20 mm, extends from the reference line 1316c to essentially the edge 1314b.

The diffuser film, at the top of the stack 1312 (in relation to the z-axis), extends from the reference line 1316a to 1316d. The diffuser film is oriented so that its scattering axis is parallel to the prism axis of the Fresnel mirror film, i.e., parallel to the y-axis in the figure, so as to scatter light in directions parallel to the length axes of the Fresnel mirrors.

Due to the different periodicity regions used in each of the two Fresnel films, a number of distinct optical patterns can be seen in the photograph. Between reference lines 1316a and 1316b, the pattern produced by the combination of a short periodicity (20 mm)

Fresnel mirror film and a long periodicity (40 mm) Fresnel lens film, also with the diffuser film, can be seen. Between reference lines 1316b and 1316c, the pattern produced by the combination of a long periodicity (40 mm) Fresnel mirror film and a long periodicity (40 mm) Fresnel lens film, also with the diffuser film, can be seen. Between reference lines 1316c and 1316d, the pattern produced by the combination of a long periodicity (40 mm) Fresnel mirror film and a short periodicity (20 mm) Fresnel lens film, with the diffuser film also, can be seen. In the narrow space between reference lines 1316d and 1316e, the pattern produced by the combination of a long periodicity (40 mm) Fresnel mirror film and a short periodicity (20 mm) Fresnel lens film, can be seen with no overlying diffuser film. In the space between reference line 1316e and edge 1314b, the Fresnel lens film can be seen by itself, with no underlying Fresnel mirror film and no overlying diffuser film.

Inspection of the photograph of FIG. 13 reveals that in the various regions of overlap between the mirror film and the lens film, one can see sand dune-like or gentle wave-like patterns similar to that of FIG. 12. Differences can be seen between the patterns as a function of the relative widths or spacings of the Fresnel structures in the Fresnel mirror and Fresnel lens films.

### Second Decorative Example

The same Fresnel mirror film and the same Fresnel lens film from the first decorative example were obtained, except that the Fresnel mirror film was cut so that it contained only the long periodicity region (40 mm sinusoidal period), and the Fresnel lens film was cut so that it contained only the short periodicity region (20 mm sinusoidal period). A film stack was produced by laying the resulting Fresnel lens film atop the resulting Fresnel mirror film, with no optical adhesive being used to bond these films together. No diffuser or diffuser film was used in the stack. The Fresnel lens film was rotated by an angle of about 45 degrees relative to the Fresnel mirror film. That is, the axis of elongation of the Fresnel lenses and the axis of elongation of the Fresnel mirrors formed an included angle of about 45 degrees.

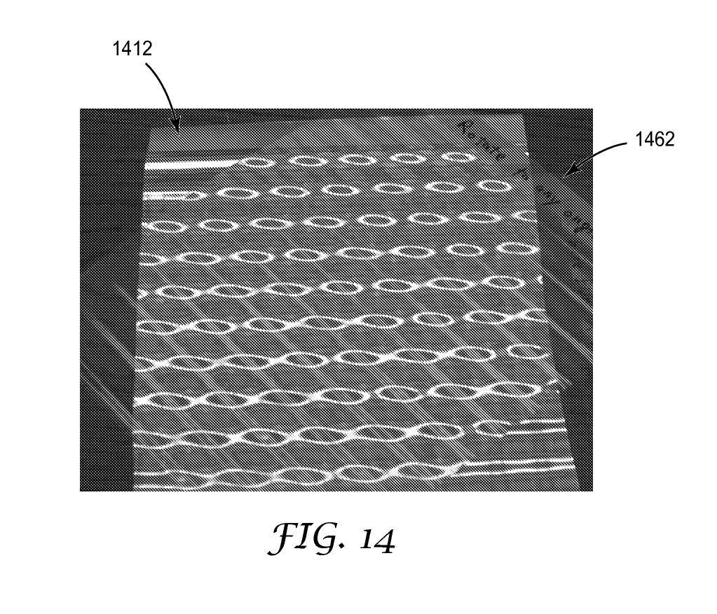

A top or front view photograph of the stack in an office environment is shown in FIG. 14, in which the Fresnel mirror film is labeled 1412 and the Fresnel lens film is labeled 1462. In the region of overlap between the mirror film 1412 and the lens film 1462, one can see a visually distinctive pattern having oval-shaped features which merge in some areas to provide a gentle wave-like quality.

The Fresnel mirror films, Fresnel lens films, and combinations thereof described herein (such as film stacks that include a Fresnel mirror film and/or a Fresnel lens film) can also comprise visible light diffractive elements that are tailored to separate visible light into its constituent wavelengths or colors to produce a multicolored or rainbow-like visual effect. The visible light diffractive elements may comprise grooves, ridges, prisms, or other features sized to provide one or more diffraction gratings. When used with a Fresnel mirror film and/or a Fresnel lens film having linearly extending Fresnel structures (mirrors or lenses, respectively), the diffraction grating(s) may also extend linearly e.g. using straight linear grooves or other diffractive features. The axis of elongation of the diffraction grating(s) may be oriented as desired with respect to the elongation axis of the Fresnel structures of the Fresnel mirror film and/or Fresnel lens film. In some cases, the diffracting grating axis may be substantially parallel to the axis of the Fresnel structures. In some cases, the diffracting grating axis may be substantially perpendicular to the axis of the Fresnel structures. In some cases, the diffracting grating axis may be oriented at an oblique angle relative to the axis of the Fresnel structures.

If a diffraction grating is included, it can be laminated to the Fresnel film, or in the case of the diffractive grooves parallel to the Fresnel prism grooves, the diffractive grooves can be cut directly into the face of some or all of the larger grooves on an embossing/casting tool. In one example, equilateral triangle-shaped prisms (60 degree apex angle) with a 600 nm repeat distance and width were cut into the face of each groove on a copper tool, the copper tool otherwise being substantially the same as that used above for the Fifth wood-like example. Thus, the copper tool had 75 micron wide grooves whose groove angles were arranged in a sinusoidal slope sequence having a period of 40 mm, and each groove also included the smaller 600 nm diffractive grooves. The diffractive grooves produced diffractive sub-structures on the Fresnel prisms in replicated polymer films. Brilliant rainbow patterns were observed on both the copper tool and on the cast and cured polymer films made with this tool. The diffractive Fresnel lens film can be metalized to provide diffractive Fresnel mirror film, which can be combined with Fresnel lens films (either with the diffractive features or without) in the same manner as described above.

In some cases, patterned planarization of the faceted or structured surface can be implemented to provide additional visually distinctive features to the disclosed films and combinations. For example, before metallizing the facets of the Fresnel structures to provide a Fresnel mirror film, selected portions of the structured surface can be image-wise coated with a polymer material or other suitable material whose thickness is great enough to planarize the structured surface. By metalizing the resulting product, Fresnel mirrors are formed everywhere on the structured surface except for the selected portions that had been planarized by the image-wise coating. The absence of Fresnel mirrors in the selected portions provides a noticeable image that can add to the visual distinctiveness of the article. The image-wise coating can have any desired image or pattern, and may be considered to be indicia. Similar patterned planarization can be done for the Fresnel lens film. The image-wise coating can be an adhesive layer that is used to bond the Fresnel film to a surface or to another Fresnel film in the absence of a low index planarization layer. The image-wise coating can be formed with clear, or color tinted, adhesives, post-curable polymeric layers, epoxies, or printing inks, using any suitable printing technique such as flexographic, gravure, screen, or ink jet.

Unless otherwise indicated, all numbers expressing quantities, measurement of properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

Various modifications and alterations of this invention will be apparent to those skilled in the art without departing from the spirit and scope of this invention, and it should be understood that this invention is not limited to the illustrative embodiments set forth herein. For example, the disclosed transparent conductive articles may also include an anti-reflective coating and/or a protective hard coat. The reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A film article having a wood-like 3-dimensional appearance, comprising:
a first film having a plurality of Fresnel mirrors, each of the Fresnel mirrors extending generally parallel to a first in-plane axis;
a diffuser disposed to scatter light reflected by the Fresnel mirrors; and
an indicia layer having wood-grain indicia, the indicia layer disposed to cover the first film.

2. The article of claim 1, wherein the diffuser is tailored to diffuse light preferentially along a second in-plane axis, and the second in-plane axis is substantially aligned with the first in-plane axis.

3. The article of claim 2, wherein the first and second in-plane axes form an angle less than 60 degrees.

4. The article of claim 2, wherein the diffuser, if illuminated by a normally incident collimated light beam, scatters the light beam by a first characteristic polar scattering angle β in a plane containing the second in-plane axis, and by a second characteristic polar scattering angle α in a plane containing a third in-plane axis perpendicular to the second in-plane axis, and wherein β/α is at least 1.5.

5. The article of claim 1, wherein the diffuser is incorporated into the indicia layer.

6. The article of claim 1, wherein at least some of the Fresnel mirrors are configured to focus incident parallel light.

7. The article of claim 1, wherein at least some of the Fresnel mirrors are configured to defocus incident parallel light.

8. The article of claim 1, wherein the Fresnel mirrors are arranged to alternate between first Fresnel mirrors configured to focus incident parallel light and second Fresnel mirrors configured to defocus incident parallel light.

9. The article of claim 1, wherein the Fresnel mirrors are contiguous to each other.

10. The article of claim 1, wherein the Fresnel mirrors are each straight in plan view.

11. The article of claim 1, wherein the wood-grain indicia comprises wood-grain features that each extend parallel to a third in-plane axis, and wherein the third in-plane axis is substantially perpendicular to the first in-plane axis.

12. The article of claim 1, wherein each of the Fresnel mirrors comprises a plurality of reflective facets formed on the first film.

13. A film article, comprising:
a first film having a plurality of Fresnel mirrors, each of the Fresnel mirrors extending generally parallel to a first in-plane axis; and
a diffuser that diffuses light preferentially along a second in-plane axis, the diffuser being disposed to scatter light reflected by the Fresnel mirrors;
wherein the second in-plane axis is substantially aligned with the first in-plane axis.

14. The article of claim 13, wherein the first and second in-plane axes form an angle less than 60 degrees.

15. The article of claim 13, wherein at least some of the Fresnel mirrors are configured to focus incident parallel light.

16. The article of claim 13, wherein at least some of the Fresnel mirrors are configured to defocus incident parallel light.

17. The article of claim 13, wherein the Fresnel mirrors each have a length-to-width aspect ratio, and the aspect ratios of the plurality of Fresnel mirrors are each greater than 10.

18. A film stack, comprising:
a first film having a plurality of Fresnel mirrors, each of the Fresnel mirrors extending generally parallel to a first in-plane axis; and
a second film having a plurality of Fresnel lenses, each of the Fresnel lenses extending generally parallel to a second in-plane axis, the second film being disposed to intercept light reflected by the Fresnel mirrors;
wherein the second in-plane axis is disposed to be non-parallel to the first in-plane axis.

19. The stack of claim 18, further comprising:
a diffuser disposed to scatter light reflected by the Fresnel mirrors;
wherein the diffuser has a haze in a range from 10% to 90%.

20. The stack of claim 18, further comprising:
a diffuser disposed to scatter light reflected by the Fresnel mirrors;
wherein the diffuser diffuses light preferentially along a third in-plane axis, the diffuser being oriented such that the third in-plane axis is perpendicular to neither the first in-plane axis nor the second in-plane axis.

21. The stack of claim 18, further comprising:
one or more colored dyes and/or pigments incorporated into one or more components of the film stack.

22. The stack of claim 18, wherein the first and second in-plane axes form an angle in a range from 5 to 90 degrees.

23. The stack of claim 18, wherein the plurality of Fresnel mirrors is characterized by an average Fresnel mirror width and the plurality of Fresnel lenses is characterized by an average Fresnel lens width different from the average Fresnel mirror width.

24. The stack of claim 18, wherein the plurality of Fresnel mirrors is characterized by a first average pitch and the plurality of Fresnel lenses is characterized by a second average pitch different from the first average pitch.

25. The stack of claim 18, further comprising:
a transparent plate having opposed first and second major surfaces;
wherein the first film attaches to the first major surface and the second film attaches to the second major surface.

26. A decorative mirror film, comprising a structured surface having facets arranged in a slope sequence from a first substantially zero slope to increasingly positive slopes to a maximum positive slope to diminishing positive slopes to a second substantially zero slope to increasingly negative slopes to a maximum negative slope to diminishing negative slopes to the first substantially zero slope, the sequence repeating in a substantially uninterrupted fashion across the structured surface, the facets defining a plurality of focusing Fresnel mirrors alternating with defocusing Fresnel mirrors.

27. The mirror film of claim 26, wherein the facets, the focusing Fresnel mirrors, and the defocusing Fresnel mirrors each extend generally parallel to a first in-plane axis.

28. The mirror film of claim 26, wherein the slope sequence is substantially sinusoidal.

29. The mirror film of claim 26, further comprising:
an indicia layer covering the focusing and defocusing Fresnel mirrors.

30. The mirror film of claim 26, further comprising:
one or more colored dyes and/or pigments incorporated into one or more components of the mirror film.

31. The mirror film of claim 26, further comprising:
visible light diffractive elements tailored to separate visible light into its constituent wavelengths or colors to produce a multicolored visual effect.

32. A film article, comprising:
the mirror film of claim 26;
a diffuser disposed to scatter light reflected by the Fresnel mirrors; and
an indicia layer having wood-grain indicia, the indicia layer disposed to cover the mirror film.
